(19) United States
(12) Patent Application Publication
(10) Pub. No.: US 2026/0289128 A1
(43) Pub. Date: Sep. 24, 2026

(54) SYSTEM

(71) Applicant: SoftBank Group Corp., Tokyo (JP)

(72) Inventor: Koutarou URAZAKI, Tokyo (JP)

(73) Assignee: SoftBank Group Corp., Tokyo (JP)

(21) Appl. No.: 19/564,258

(22) Filed: Mar. 12, 2026

(30) Foreign Application Priority Data
Mar. 19, 2025 (JP) 2025-044898

(51) Int. Cl. G06F 40/289; G06F 40/211; G06F 40/253; G06F 40/268; G06F 40/284; G06F 40/30; G06F 40/40; G06N 3/0475

(52) U.S. Cl. CPC G06F 40/289; G06F 40/211; G06F 40/253; G06F 40/268; G06F 40/284; G06F 40/30; G06F 40/40; G06N 3/0475

(57) ABSTRACT

A system includes a processor that is configured to use a microphone to acquire audio information and convert the audio information into a digital signal, execute a speech recognition algorithm to convert the digital signal into character information, and generate a prompt sentence for instructing a generative AI model to acquire information and input the prompt sentence to the generative AI model.

### CROSS-REFERENCE TO RELATED APPLICATION

This application is based on and claims priority under 35 USC 119 from Japanese Patent Application No. 2025-044898 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional meeting support systems, participants who encounter unfamiliar terms or require additional background information must interrupt the discussion to manually search external resources, consult separate documents, or ask other participants for clarification. The need to perform such manual information retrieval disrupts the flow of the meeting, reduces overall efficiency, and may prevent participants from fully understanding the content in real time. In particular, when technical terms, newly coined expressions, or domain-specific jargon are used, participants who are not experts in the relevant field may be unable to follow the discussion without repeated clarification. Furthermore, existing automatic speech recognition systems merely convert speech into text and do not automatically trigger context-appropriate queries to external knowledge sources, such as generative AI models, based on the recognized content. As a result, existing systems fail to provide immediate, meeting-specific explanations or detailed information corresponding to unknown phrases or requested topics. Accordingly, there is a need for a system that can automatically convert spoken audio into text, generate suitable prompts for a generative AI model, and acquire explanations or detailed information in real time without requiring manual search operations by participants.

### SUMMARY

To solve the above-described problems, the present invention provides a system comprising a processor, wherein the processor is configured to use a microphone to acquire audio information and convert the audio information into a digital signal, execute a speech recognition algorithm to convert the digital signal into character information, and generate a prompt sentence for instructing a generative AI model to acquire information and input the prompt sentence to the generative AI model. In one aspect, the processor is configured to generate a prompt sentence for instructing the generative AI model to generate an explanation related to an unknown phrase contained in the character information and input the prompt sentence to the generative AI model, thereby enabling automatic generation of context-appropriate explanations for terms that are not familiar to the participants. In another aspect, the processor is configured to generate, in real time during a meeting, a prompt sentence for immediately acquiring detailed information requested during the meeting and input the prompt sentence to the generative AI model, thereby allowing participants to obtain necessary detailed information without interrupting the progression of the meeting. By combining real-time audio acquisition, speech recognition, and automatic prompt generation for a generative AI model, the system of the present invention enables on-demand retrieval of explanations and detailed information directly from the ongoing spoken content, improving comprehension and maintaining the smooth flow of the meeting.

The term “processor” refers to a hardware or hardware-and-software computing component that executes instructions to perform operations including audio acquisition control, signal processing, speech recognition, and generation and transmission of prompt sentences.

The term “microphone” refers to a hardware input device that converts sound waves corresponding to audio information, such as speech during a meeting, into an electrical signal that can be further processed as a digital signal.

The term “audio information” refers to sound data, including spoken words and other acoustic signals generated during a meeting or conversation, that is acquired by the microphone for processing by the system.

The term “digital signal” refers to an electronic representation of audio information in a discrete, quantized form suitable for processing by the processor, including storage, transmission, and conversion into character information.

The term “speech recognition algorithm” refers to software or a set of computational procedures executed by the processor to analyze the digital signal and convert the spoken audio contained in the digital signal into corresponding character information.

The term “character information” refers to textual data, including characters, words, and sentences, that represent the content of the spoken audio after conversion by the speech recognition algorithm.

The term “prompt sentence” refers to a text string generated by the processor that is formatted to instruct a generative AI model to perform a specific task, such as acquiring information, generating an explanation, or providing detailed information.

The term “generative AI model” refers to an artificial intelligence model, typically implemented as a machine learning or deep learning model, that generates text or other content in response to an input prompt sentence, based on patterns learned from training data.

The term “unknown phrase” refers to a word, term, or expression included in the character information that is presumed to be unfamiliar, unclear, or not previously defined for at least one participant, and for which an explanation is requested or required.

The term “explanation” refers to a text output generated by the generative AI model that describes, defines, or clarifies the meaning or context of an unknown phrase to enhance understanding by a participant.

The term “detailed information” refers to additional, more specific, or extended text output generated by the generative AI model in response to a prompt sentence, including examples, background, technical details, or further elaboration requested during a meeting.

The term “real time” refers to processing that is performed with a latency sufficiently short that the acquisition of audio information, generation of prompt sentences, and receipt of responses from the generative AI model occur during the ongoing meeting without substantially interrupting the flow of the discussion.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

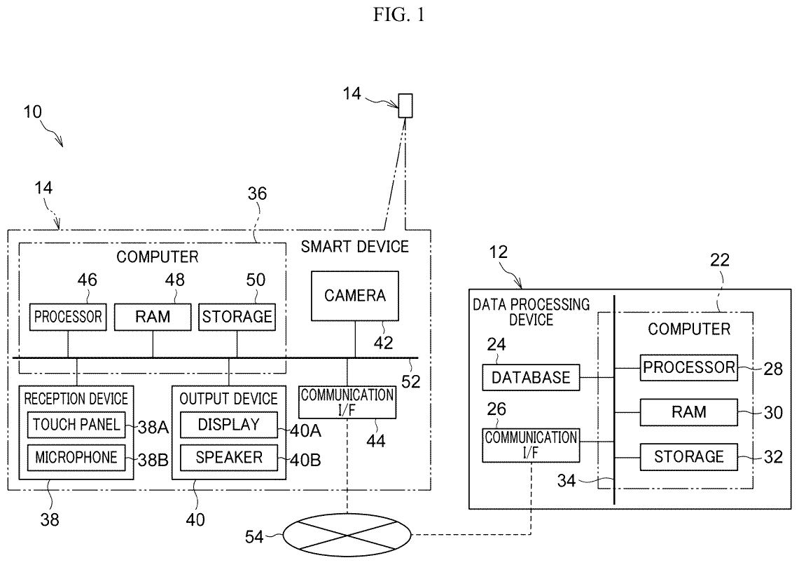

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

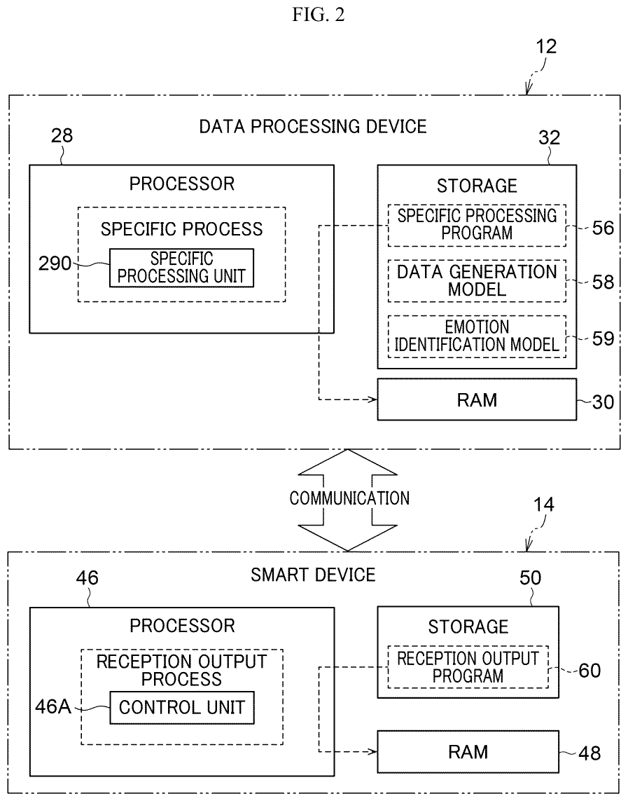

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional meeting assistance systems that generate minutes or indexes from spoken conversations typically rely on fixed keyword lists, simple speech-to-text pipelines, or rule-based extraction logic executed after a meeting has concluded. Such systems suffer from several technical shortcomings in terms of computer performance and information processing quality. First, these systems often treat audio capture, speech recognition, linguistic analysis, and index generation as loosely coupled or batch processes, which introduces latency and prevents the computing system from responding to user information needs in real time during an ongoing meeting. Second, conventional approaches generally perform shallow text analysis without maintaining fine-grained associations between audio segments, recognized text, and higher-level concepts, which results in inefficient storage structures, redundant computations, and limited support for interactive navigation. Third, when unknown phrases or complex domain-specific expressions arise, existing systems typically cannot automatically obtain context-sensitive explanatory or background information; instead, users must manually search external resources, which interrupts workflows and increases cognitive load. Fourth, prior systems do not effectively integrate generative AI models as part of a coordinated computational pipeline in which prompt sentences are dynamically generated based on continuously updated linguistic and structural information; as a result, the computing resources of such models are either underutilized or invoked in a way that produces unstructured, difficult-to-integrate outputs.

As the volume and velocity of meeting data increase, these limitations lead to wasted processor cycles, inefficient memory and storage access patterns, and degraded user experience on terminal devices. There is therefore a need for a computer-implemented system that technically improves how processors acquire audio, transform it into structured linguistic representations, compute and update item index information, and orchestrate real-time interactions with a generative AI model through dynamically generated prompt sentences. Such a system should reduce end-to-end latency, avoid redundant computations, and provide a richer, automatically maintained structure over meeting content, thereby improving the functioning of the underlying computer system itself rather than merely automating a human mental process.

The specific processing by the specific processing unit 290 of the data processing device 12 in Example 1 is realized by the following means.

The present invention provides a server comprising a processor configured to acquire acoustic signals via an acoustic input device and convert the acoustic signals into digital audio data, convert the digital audio data into character information using an external speech recognition function while generating a speech record that associates the character information with corresponding portions of the digital audio data, apply a natural language processing function to the character information to perform word segmentation, obtain part-of-speech information, syntactic information, and entity information, and extract important phrase candidates, calculate occurrence frequency information, importance indices, and mutual similarity values for the important phrase candidates and integrate the important phrase candidates into concept units to generate item index information as structured data, generate a prompt sentence that specifies processing contents for a generative information processing model based on at least the character information and the item index information and input the prompt sentence and the character information into the generative information processing model to cause the generative information processing model to output at least one of corrected item index information and summary information, and transmit the item index information and response information returned from the generative information processing model to a user terminal device in a format suitable for visual presentation as a meeting record and an item index. This enables the server to operate as an integrated computational pipeline that maintains explicit associations between audio data, recognized text, and higher-level concept structures, dynamically refines those structures using the generative information processing model, and incrementally delivers structured, query-ready information to the user terminal device with reduced latency, improved indexing accuracy, and more efficient use of processing and storage resources.

The term “acoustic input device” refers to any hardware component configured to capture sound waves from a physical environment and convert the sound waves into electrical signals, including but not limited to microphones, headsets, and integrated audio input modules of computing devices.

The term “acoustic signal” refers to an analog or digital representation of sound generated in a physical environment, including spoken utterances in a meeting, that is suitable for processing by an audio input subsystem of a computing device.

The term “digital audio data” refers to audio information obtained by sampling and quantizing an acoustic signal at discrete time intervals, represented in a machine-readable format such as pulse code modulation or encoded audio frames.

The term “external speech recognition function” refers to any software or hardware module, including a remote service accessible over a communication network, that receives digital audio data and outputs corresponding character information by performing automatic speech recognition.

The term “character information” refers to machine-readable textual data that results from converting digital audio data into text, including sequences of characters, words, and sentences representing recognized speech content.

The term “speech record” refers to a structured data object that stores character information together with association information linking the character information to corresponding portions of digital audio data or time positions in an acoustic signal.

The term “association information” refers to metadata that correlates elements of character information with related elements of audio data, such as time stamps, segment identifiers, speaker identifiers, or positional indices.

The term “natural language processing function” refers to one or more software routines or models configured to analyze character information, including operations such as tokenization, part-of-speech tagging, syntactic parsing, and entity recognition.

The term “word segmentation” refers to processing that divides character information into smaller units, such as tokens or words, based on linguistic rules or statistical models, for subsequent analysis.

The term “part-of-speech information” refers to classification data that indicates grammatical categories for tokens in character information, such as nouns, verbs, adjectives, and other syntactic roles.

The term “syntactic information” refers to structural data describing grammatical relationships among tokens in character information, including dependency relations, phrase structures, and clause boundaries.

The term “entity information” refers to annotations or metadata identifying mentions of entities within character information, including names of persons, organizations, locations, products, or other salient items.

The term “important phrase candidate” refers to a segment of character information, such as a word sequence or phrase, that is identified by the natural language processing function as potentially representing a key concept, topic, decision, or action item in a meeting.

The term “occurrence frequency information” refers to numerical data indicating how often a particular phrase or token appears within character information or within a collection of related documents.

The term “importance index” refers to a computed metric that quantifies the relative significance of a phrase or token within character information, based on factors such as frequency, position, repetition, and linguistic context.

The term “mutual similarity” refers to a measure of relatedness between two or more phrases or tokens, determined using methods such as vector similarity, string similarity, or semantic similarity.

The term “concept unit” refers to a logical grouping of one or more related phrases or tokens that collectively represent a single topic, subject, or semantic concept within meeting content.

The term “item index information” refers to structured data describing a set of concept units, phrases, or topics extracted from character information, including their identifiers, importance measures, and references to locations in the underlying meeting record.

The term “structured data” refers to data arranged in a predefined format, such as records, tables, objects, or hierarchical structures, that allows deterministic access to individual fields or attributes by a computing system.

The term “prompt sentence” refers to a machine-readable instruction sequence in natural or semi-structured language that specifies a processing task to be executed by a generative information processing model.

The term “generative information processing model” refers to a computational model, such as a neural network-based model, configured to generate text or other structured outputs in response to an input including a prompt sentence and optional context data.

The term “response information” refers to output data produced by a generative information processing model in response to a prompt sentence, including corrected item index information, summary information, explanations, or other generated content.

The term “summary information” refers to generated character information that condenses and restructures content from character information or item index information into a shorter representation preserving core meanings or decisions.

The term “user terminal device” refers to any computing device operated by a user, such as a mobile terminal, a personal computer, or a tablet, that is configured to receive, display, and optionally interact with a meeting record and item index information.

The term “meeting record” refers to a representation of meeting content including at least character information derived from spoken utterances and optionally associated metadata such as time stamps, speakers, and topics.

The term “visually presentable format” refers to a layout or data representation suitable for display on a screen of a user terminal device, including formats such as lists, tables, timelines, or linked text views that allow a user to perceive and navigate information.

In an embodiment, a server, a terminal, and a user cooperate to implement a system that records meeting audio, converts the audio into structured text, computes item index information, and refines that information using a generative AI model based on dynamically generated prompt sentences.

The server includes at least one processor, a volatile memory device, a non-volatile storage device, and a network interface. The server executes an operating system, for example a general-purpose server operating system, and application software implementing audio processing, natural language processing, and generative AI integration. The terminal includes at least one processor, a display, an audio input device such as a microphone or headset, and a communication module such as a wireless network interface. The user operates the terminal during a meeting to provide spoken utterances and to view the generated meeting record and item index.

The server uses the network interface to receive digital audio data that the terminal acquires via the acoustic input device. The terminal uses an audio input subsystem, such as an operating system audio framework, to sample and quantize an acoustic signal at a fixed sampling rate and bit depth. The terminal packages the digital audio data into frames and transmits the frames to the server over a secure communication protocol, for example an encrypted transport protocol, together with metadata such as a session identifier, language code, and approximate time stamps.

The server uses an external speech recognition function to convert the digital audio data into character information. In one embodiment, the server calls a cloud-based automatic speech recognition service via a network API. The server buffers audio frames in memory, groups the frames into recognition segments, and transmits the segments to the speech recognition service together with configuration parameters such as language, punctuation settings, and acoustic model selection. The server receives recognition results that include recognized text, confidence scores, and word-level time offsets. The server stores the digital audio data and the resulting character information in an associated data structure, for example a speech record object that includes fields for segment identifiers, time offsets, speaker identifiers, and text content.

The server applies a natural language processing function to the character information. The server uses one or more NLP libraries, such as a tokenization and parsing library, executed by the processor to divide the character information into tokens, determine part-of-speech tags, and compute syntactic dependencies. The server constructs an internal representation for each utterance, for example a document object containing a list of token objects, each with fields storing the token string, normalized form, part-of-speech tag, dependency relation, and character offset. The server further applies an entity recognition model that labels spans of tokens as entities such as person names, organization names, locations, or domain-specific terms.

The server extracts important phrase candidates from the NLP results by applying rule-based filters and statistical measures. The server identifies noun phrases, verb-object pairs, and entity mentions that satisfy predefined structural patterns, such as a head noun with at least one modifier, or a verb with a direct object. The server computes term frequency and inverse document frequency values across the current meeting and, optionally, across a corpus of past meetings stored in the storage device. The server assigns an importance index to each phrase candidate based on term frequency, inverse document frequency, syntactic role (for example, main predicate versus subordinate clause), and recurrence across distinct segments. The server discards low-information phrases such as generic acknowledgments or stop words using a stored list of stop words and domain-independent phrases.

The server calculates mutual similarity between important phrase candidates to group them into concept units. The server maps each phrase candidate to a vector representation using a language model, such as a word embedding or sentence embedding model previously trained on large corpora. The server computes similarity scores between pairs of phrase vectors using a distance metric such as cosine similarity. The server applies a clustering algorithm, for example a hierarchical or density-based clustering algorithm, to group phrase candidates that exceed a similarity threshold into a single concept unit. The server stores for each concept unit a canonical phrase, a list of member phrases, an aggregated importance index, and references to the corresponding positions in the character information and speech record.

The server generates item index information as structured data based on the concept units. The server constructs an item index data structure, for example a list of index entries where each entry includes a concept identifier, the canonical phrase, the aggregated importance index, a category label such as “decision” or “action,” and a list of occurrence records. Each occurrence record includes the time offsets from the audio, the utterance identifier, the speaker identifier, and a short excerpt of surrounding text. The server stores the item index in the non-volatile storage device in a format that supports indexed access by concept identifier, time interval, or category.

The server generates a prompt sentence for a generative AI model based on the character information and the item index information. The server uses a prompt generation module that selects a prompt template from a set of stored templates and fills template variables using the current meeting context. For example, the server selects a template for refining an item index and inserts into the template: summary statistics about the number of concept units, a subset of the highest-ranked phrases, and instructions regarding the desired output structure. The server transmits the prompt sentence and relevant portions of the character information to a generative AI model via a network API.

In one embodiment, the server uses a generative AI model implemented as a neural network model having a transformer architecture with multiple self-attention layers, feed-forward layers, and layer normalization. The neural network is trained beforehand using supervised learning and unsupervised language modeling on a large corpus of text. During training, the model uses a loss function such as cross-entropy between predicted tokens and target tokens, and updates weights using a gradient-based optimization algorithm. The model parameters are stored in a model serving infrastructure accessible via a network endpoint. The server provides inputs to this model in the form of tokenized prompt sentences and, optionally, concatenated excerpts of the meeting transcript.

The server receives response information from the generative AI model. The response information may include a refined set of important phrases, corrections to category labels, new summary sentences for each concept unit, or an overall meeting summary. The server parses the textual response, for example by applying a response parser that identifies sections corresponding to concepts, categories, and summaries using pattern matching rules. The server merges the parsed response with the existing item index by adding new fields such as “model_summary” to each index entry, updating importance indices when the model suggests re-ranking, and adding new concept units when the model identifies previously ungrouped phrases.

The server generates prompt sentences dynamically for unknown phrases and newly detected important phrases. When the server detects a token sequence that has low familiarity according to a stored vocabulary, or that carries a high importance index but lacks contextual explanation, the server constructs a specific prompt sentence such as:
“Explain the meaning and background of the following term in the context of a project meeting: ‘[term]’. Provide a concise explanation suitable for non-experts.”
or
“Summarize the key considerations and potential risks associated with the following topic mentioned in a meeting: ‘[topic phrase]’.”

The server then transmits the prompt sentence to the generative AI model, receives the explanatory response, and stores the explanation text associated with the corresponding item index entry.

The server transmits the item index information and response information to the terminal in a format suitable for visual presentation. The server converts the internal data structures into a transmission format, for example a structured document containing fields for segments, index entries, and summaries. The server uses the network interface to send this document to the terminal. The terminal parses the received data and renders a graphical user interface that displays the meeting record as a chronological list of utterances together with a side panel showing the item index entries. The terminal allows the user to select an index entry, upon which the terminal uses the stored time offsets to scroll the meeting record display to the corresponding section and optionally to request an audio playback starting at the associated time.

The server improves computing performance relative to conventional systems by maintaining structured associations between audio segments, recognized text, and concept units. Because the server stores time offsets and identifiers at each processing stage, the server avoids recomputing NLP features when updating the item index and can selectively reprocess only those segments affected by new input. This reduces processor cycles and memory accesses. The server further reduces communication overhead between the server and the generative AI model by generating compact prompt sentences that include only the most relevant portions of the transcript, instead of transmitting complete raw transcripts repeatedly.

The server improves accuracy and robustness by combining rule-based NLP extraction with vector-based clustering and generative AI refinement. The initial extraction ensures that phrase candidates meet well-defined syntactic criteria, which reduces noise. The vector similarity clustering groups phrases that are semantically related but lexically different, such as “review budget” and “budget verification,” allowing the system to produce more stable concept units. The generative AI model then refines these units by using its learned language patterns to identify missing connections or misclassified categories. This layered approach reduces error rates in indexing and yields a more precise representation of meeting topics.

The server improves data management by storing item index information as structured data with indexed fields, which allows efficient query operations on concept identifiers, categories, or time ranges. When the user requests navigation to a particular topic, the server retrieves the relevant index entry and associated occurrence records in a single lookup and returns focused results. This structure also enables incremental updates: the server appends new index entries and updates existing entries as the meeting progresses, rather than regenerating the entire index from scratch.

The server employs internal rules and processing methods that differ from conventional human note-taking. For example, the server assigns weights to phrases based on a combination of statistical features, syntactic roles, and semantic similarity scores, whereas a human notetaker typically relies on intuitive judgment. The server uses formal clustering algorithms and embedding-based similarity metrics to aggregate concepts, which allow it to consistently group related phrases even across long meetings. The server also uses explicit criteria and thresholds stored as configurable parameters for determining when to request explanations from the generative AI model, such as a minimum importance index and a maximum familiarity score.

The server can employ alternative generative AI models and architectures. In one embodiment, the server uses a sequence-to-sequence model with encoder-decoder structure. The encoder processes the meeting transcript and item index as token sequences, producing a set of contextual embeddings. The decoder receives a prompt sentence token sequence and the encoder outputs via attention mechanisms and generates the refined index or summary. The model is trained with supervised pairs of transcripts and human-annotated summaries or indexes, using an error function such as negative log-likelihood of target tokens. During deployment, the server adjusts decoding parameters such as beam width and temperature to control the precision and diversity of generated outputs.

In another embodiment, the server hosts the generative AI model locally rather than calling a remote service. The server loads model parameters from storage into memory, initializes a runtime engine optimized for matrix operations on a hardware accelerator such as a graphics processing unit or tensor processing unit, and executes inference on the local hardware. This configuration reduces network latency and increases throughput when processing large numbers of meetings.

The terminal can take various forms. In one embodiment, the terminal is a mobile device executing a native application that provides a real-time transcript view, an index view, and a summary view. In another embodiment, the terminal is a desktop computer running a web browser that connects to the server via a web application. In all embodiments, the terminal presents the item index entries in a clickable list, allows filtering by category such as “decisions” or “action items,” and displays explanatory texts retrieved from the generative AI model when the user selects unknown or specialized terms.

The user interacts with the system by speaking during the meeting, optionally marking specific moments for emphasis via user interface controls, and later browsing the generated item index and summaries. The user can request additional detail for an item by selecting a prompt associated with that item, upon which the server may generate a new prompt sentence such as:
“From the context of this meeting, list concrete next steps related to: ‘[item phrase]’, and describe each step in one sentence.”

The server then obtains and presents the generated response.

Through these configurations, the server, the terminal, and the user realize a concrete technical system in which the processor's operation is improved. Latency is reduced by streaming audio and incremental index updating, accuracy is improved by combined NLP and generative modeling with structured feedback integration, data management is improved by explicit speech records and item index structures, and communication overhead is reduced by carefully designed prompt sentences and selective context transmission. The system therefore provides more than an automation of human note-taking; it achieves a technical improvement in how computers process, structure, and present continuous audio and text data in real time.

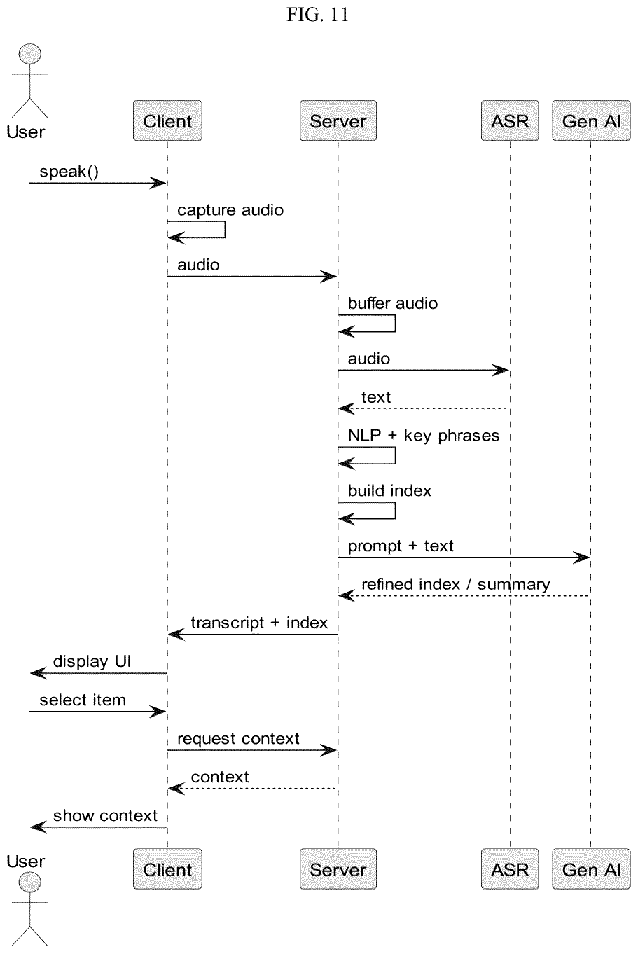

The following describes the processing flow using FIG. 11.

### Step 1

The user speaks during a meeting while using a microphone.

The terminal receives, as input, an analog acoustic signal generated by the user's voice. The terminal samples and quantizes the acoustic signal using an audio input subsystem to obtain, as output, digital audio data in frames (for example, 16 kHz, 16-bit linear PCM). The terminal performs data processing that includes reading raw samples from the microphone driver, segmenting the stream into fixed-length buffers, and attaching local time stamps to each buffer.

### Step 2

The terminal transmits the digital audio data to the server.

The terminal receives, as input, the framed digital audio data and associated local metadata such as a meeting identifier, a user identifier, and a language code. The terminal opens a secure network connection to the server and sends, as output, a sequence of audio frames and metadata packets. The terminal performs data processing that includes encapsulating audio frames into network messages, adding headers containing session identifiers and time stamps, and using a transport protocol to stream the data in near real time.

### Step 3

The server receives and buffers the digital audio data.

The server receives, as input, the streamed audio frames and metadata from the terminal. The server stores, as output, the audio frames in an input buffer in memory and optionally in a persistent storage area for later access. The server performs data processing that includes validating session identifiers, ordering frames by arrival time, merging adjacent frames into longer segments, and creating internal segment records that store buffer offsets, time ranges, and meeting context.

### Step 4

The server converts the digital audio data into character information using a speech recognition function.

The server receives, as input, the buffered audio segments and their time ranges. The server packages each segment into a required audio format and sends the formatted segments to an external speech recognition function, and receives, as output, recognition results containing text strings, confidence scores, and word-level time offsets. The server performs data processing that includes encoding the audio in the required codec, generating recognition requests with configuration parameters, parsing the recognition responses, and writing the recognized text and time offsets into a speech record data structure linked to the original segment identifiers.

### Step 5

The server normalizes and segments the recognized text.

The server receives, as input, the raw recognized text strings and associated time offsets stored in the speech record. The server outputs normalized character information divided into sentence units. The server performs data processing that includes converting characters to a canonical form, normalizing punctuation, splitting long text into sentences based on language-specific rules, and assigning sentence-level time ranges by combining the word-level time offsets within each sentence.

### Step 6

The server analyzes the character information using a natural language processing function.

The server receives, as input, the normalized sentences and their metadata. The server outputs structured linguistic annotations, including tokens, part-of-speech tags, syntactic dependencies, and entity labels. The server performs data processing that includes tokenizing each sentence into tokens, assigning grammatical categories using a trained tagging model, computing dependency relationships using a parsing model, and detecting entities using an entity recognition model. The server stores the results in an internal representation where each token and entity is associated with the originating sentence and time range.

### Step 7

The server extracts important phrase candidates from the linguistic annotations.

The server receives, as input, the tokens, syntactic dependencies, and entity labels for all sentences. The server outputs a list of important phrase candidates, each with a reference to its position in the character information and time range. The server performs data processing that includes selecting token spans that match syntactic patterns such as noun phrases and verb-object structures, retrieving entity spans that represent names or technical terms, applying rule-based filters to remove trivial expressions, and recording each selected span with its surrounding context and sentence identifier.

### Step 8

The server computes statistical features for the phrase candidates.

The server receives, as input, the list of phrase candidates and the full set of tokens from the meeting. The server outputs, for each phrase candidate, occurrence frequency information and an importance index. The server performs data processing that includes counting how many times each phrase string appears across sentences, optionally comparing those counts with global frequency data from stored historical meetings, computing term frequency and inverse document frequency values, and combining these values with position-based weights to calculate an importance score for each phrase.

### Step 9

The server groups phrase candidates into concept units using similarity measures.

The server receives, as input, the phrase candidates and their importance indices. The server outputs a set of concept units, each containing one or more related phrases and an aggregated importance index. The server performs data processing that includes transforming each phrase into a vector representation using a stored embedding model, calculating pairwise similarity scores between phrase vectors using a similarity function, applying a clustering algorithm to group phrases that exceed a similarity threshold, and computing an aggregated importance index for each group by combining the scores of its member phrases.

### Step 10

The server generates item index information as structured data.

The server receives, as input, the concept units and their member phrase references. The server outputs item index information in a structured form including index entries, occurrence lists, and category labels. The server performs data processing that includes creating an index entry for each concept unit, selecting a canonical phrase as the index term, attaching the aggregated importance index, collecting all occurrence records from member phrases, and assigning an initial category such as “topic,” “action,” or “decision” based on syntactic patterns and keyword rules. The server stores the resulting index entries in a data structure keyed by concept identifiers.

### Step 11

The server constructs a prompt sentence for a generative AI model based on the item index and character information.

The server receives, as input, summary statistics of the item index, selected high-importance index entries, and segments of the character information. The server outputs a prompt sentence that describes a requested processing task for the generative AI model. The server performs data processing that includes choosing a prompt template from a stored set, inserting specific phrases and context excerpts into placeholder positions, and concatenating instruction text with examples of index entries. For example, the server may generate the following prompt sentence:
“Convert the following meeting transcript into a refined item index. Extract important phrases related to actions, decisions, and risks, group similar phrases, and output a list of items, each with a short summary.”

### Step 12

The server sends the prompt sentence and context to the generative AI model and obtains response information.

The server receives, as input, the constructed prompt sentence and the selected segments of the meeting transcript. The server outputs response information containing refined index entries, explanations, or summaries. The server performs data processing that includes tokenizing the prompt and transcript, packaging the tokens into a request for the generative AI model, transmitting the request via a model API, receiving generated text, and storing the generated text as response information.

### Step 13

The server parses and integrates the response information into the item index.

The server receives, as input, the raw textual response from the generative AI model and the previously generated item index. The server outputs an updated item index in which entries may have revised rankings, added summaries, or new concepts. The server performs data processing that includes scanning the response text for structured sections corresponding to phrases and categories, mapping each generated phrase to an existing index entry by similarity or direct matching, updating importance indices and category labels when indicated, adding explanatory text fields to index entries, and creating new index entries when the response includes phrases not previously present.

### Step 14

The server generates prompt sentences for unknown or important phrases requiring explanation.

The server receives, as input, the item index entries and linguistic annotations indicating which phrases are unknown or domain-specific. The server outputs prompt sentences targeted at generating explanations or background. The server performs data processing that includes selecting index entries whose phrases meet criteria such as high importance index and low familiarity score, creating individual prompts such as “Explain the meaning and background of the term: ‘[phrase]’ in the context of a meeting,” and queuing these prompt sentences for subsequent transmission to the generative AI model.

### Step 15

The server receives and stores explanatory response information from the generative AI model.

The server receives, as input, the explanatory prompts and the generated responses from the generative AI model. The server outputs updated index entries containing associated explanatory texts. The server performs data processing that includes linking each response to the originating index entry, storing the explanation as a separate field, and marking the entry as having explanation metadata available for display on the terminal.

### Step 16

The server prepares data for presentation on the terminal.

The server receives, as input, the finalized item index information, the character information, and any summaries or explanations from the generative AI model. The server outputs a presentation-oriented data package for the terminal. The server performs data processing that includes organizing the transcript into ordered segments, arranging index entries sorted by importance and category, embedding references between index entries and transcript segments, and formatting the combined data into a structured response that the terminal can render.

### Step 17

The terminal receives and displays the meeting record and item index.

The terminal receives, as input, the structured response containing transcript segments, index entries, and generated summaries or explanations. The terminal outputs a visual user interface showing the meeting record and item index on the display. The terminal performs data processing that includes parsing the structured response, constructing UI components such as a scrollable transcript view and an index list, placing clickable elements for each index entry, and visually linking transcript text and index terms through highlighting or color coding.

### Step 18

The user interacts with the displayed item index and meeting record.

The user receives, as input, the visual display of index entries, transcript segments, and explanations. The user outputs interaction events such as taps or clicks on specific index entries. The user's actions cause, as a result, navigation commands to be issued to the terminal and optionally to the server. The user thereby triggers operations including jumping the transcript view to a selected time offset, expanding explanation text for an unfamiliar term, or requesting additional refinement, based on the item index that the server has computed and updated using the generative AI model and prompt sentences.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented assistance systems that process human speech in real time, such as meeting assistants or in-vehicle assistants, generally employ a pipeline in which speech recognition produces a flat text stream that is then searched or keyword-matched in a rudimentary manner. Such systems typically lack structured indexing of the recognized text, lack robust intent classification tied to that structure, and interact with generative AI models using ad-hoc or static prompts that do not leverage the full conversational context. As a result, these systems often return irrelevant or overly generic information, respond slowly, and require repeated manual input by the user to refine queries.

From a computer-technology standpoint, existing architectures fail to exploit the available intermediate representations (such as token-level and sentence-level linguistic features, occurrence positions, and frequency statistics) to build efficient data structures for real-time retrieval in resource-constrained environments such as autonomous vehicles or embedded meeting terminals. They also fail to systematically couple those data structures with intent classification and prompt generation logic, resulting in inefficient use of processing resources, unnecessary network traffic to external services, and suboptimal utilization of generative AI models.

Further, when operating in dynamic environments, such as inside an autonomous mobile body, conventional systems do not effectively integrate current position information, surrounding facility information, and conversation context into a unified processing flow. The absence of an integrated mechanism for (i) generating and maintaining index information over the recognized text, (ii) classifying intent information relating to user interest items and movement destinations, and (iii) constructing context-rich prompt sentences for generative AI models, leads to degraded responsiveness and accuracy. This in turn limits the ability of the computer system to provide timely, context-aware explanations and recommendations in an interactive format.

Accordingly, there is a need for a computer-implemented technique that improves the functioning of the computer itself by organizing recognized speech into structured index information, by classifying user intent in real time, and by programmatically generating prompt sentences that incorporate both conversation context and external information such as surrounding facility information. Such a technique should reduce processing overhead, improve retrieval accuracy, and enhance the effectiveness of interactions with generative AI models, thereby enabling the system to provide more relevant, timely, and context-sensitive information to the user.

The specific processing by the specific processing unit 290 of the data processing device 12 in Application Example 1 is realized by the following means.

The present invention provides a server comprising a processor configured to acquire acoustic information via an electroacoustic transducer and convert the acoustic information into a digital signal, execute speech recognition processing on the digital signal to convert the digital signal into character information, execute natural language processing on the character information to perform morphological analysis and syntactic analysis and to extract expressions, generate index information based on occurrence position information and occurrence frequency information of the extracted expressions and store the index information in association with the character information in a storage device, classify intent information indicating a user interest item and a movement destination based on the character information, specify a target for assignment of location information based on the intent information and the index information and search a storage device for location-related information corresponding to the target to acquire related information, generate a prompt sentence based on description request information including an expression selected by a user from among the character information and context information before and after the expression, the prompt sentence instructing a generative AI model to generate explanation information or recommendation information, input the prompt sentence to the generative AI model, and integrate the related information acquired by search and generated information acquired from the generative AI model and control presentation of the integrated information in an interactive format to a user terminal. This enables the computer system to internally organize recognized speech into structured index information, to automatically derive intent information and relevant external information, and to construct context-rich prompt sentences for a generative AI model in a programmatic and repeatable manner, thereby improving retrieval efficiency, reducing unnecessary processing, and enhancing the relevance and timeliness of explanations and recommendations presented to the user.

The term “acoustic information” refers to information representing sound waves in an environment, including human speech and ambient sounds, that can be captured by an electroacoustic transducer and processed by a computer system.

The term “electroacoustic transducer” refers to a hardware device that converts sound waves into electrical signals, such as a microphone or microphone array, usable as input to a processor.

The term “digital signal” refers to a time-discrete, quantized representation of an analog electrical signal obtained from an electroacoustic transducer, which is suitable for processing by a digital processor.

The term “speech recognition processing” refers to computer-implemented processing that converts a digital signal representing speech into character information by applying an acoustic model, a language model, or a combination thereof.

The term “character information” refers to text data, including characters, symbols, and punctuation, that represents the content of recognized speech in a machine-readable format.

The term “natural language processing” refers to computer-implemented analysis of character information to extract linguistic structure and meaning, including tokenization, morphological analysis, syntactic analysis, and semantic analysis.

The term “morphological analysis” refers to processing that segments character information into minimal linguistic units and determines attributes such as part of speech, inflection, or lemma for each unit.

The term “syntactic analysis” refers to processing that determines structural relationships among linguistic units within character information, such as phrase boundaries, dependency relations, or grammatical roles.

The term “expression” refers to a linguistic unit obtained from character information, including a word, a term, a phrase, or a multi-word expression, that can be used for indexing, intent classification, or prompt generation.

The term “index information” refers to structured data that associates each expression with at least occurrence position information and occurrence frequency information within character information, enabling efficient retrieval of relevant portions of the character information.

The term “occurrence position information” refers to information indicating where an expression appears within character information, including a character offset, a token index, a sentence index, a time stamp, or any combination thereof.

The term “occurrence frequency information” refers to information indicating how often an expression appears within character information, including a raw count, a normalized count, or a weighting factor derived from frequency.

The term “storage device” refers to a hardware component or a combination of hardware components capable of storing data in a non-transitory manner, such as a semiconductor memory, a magnetic storage medium, or an optical storage medium.

The term “intent information” refers to information indicating a purpose, desire, or requirement inferred from character information, including but not limited to a user interest item or a movement destination.

The term “user interest item” refers to a category or topic inferred from character information that reflects a user's current preference or need, such as food, sightseeing, shopping, or lodging.

The term “movement destination” refers to a geographic location, facility, or area inferred as a potential travel target for a user, based on character information and optionally current position information.

The term “target for assignment of location information” refers to an entity, such as an expression or an intent, that is selected by the processor as a basis for associating geographic or facility-related data.

The term “location-related information” refers to information associated with a geographic point or area, including surrounding facility information, address information, route information, or attribute information of facilities.

The term “related information” refers to information obtained by searching a storage device based on a target for assignment of location information, including but not limited to facility candidates, descriptive data, and metadata associated with such facilities.

The term “description request information” refers to information indicating that explanation information or recommendation information is to be generated, the information including at least an expression selected by a user and context information before and after the expression.

The term “context information” refers to character information surrounding a particular expression, including preceding and following sentences, clauses, or phrases that provide semantic background for the expression.

The term “prompt sentence” refers to text data constructed by the processor and supplied as input to a generative AI model, the text data specifying an instruction or request for generation of explanation information or recommendation information.

The term “generative AI model” refers to a computer-implemented probabilistic model, such as a neural network model, that generates text or other content in response to input data, including a prompt sentence.

The term “explanation information” refers to information generated or selected by the system that clarifies the meaning, background, or relevance of an expression, topic, or facility in human-readable form.

The term “recommendation information” refers to information generated or selected by the system that proposes one or more options, such as facilities or actions, together with reasons or attributes supporting the proposal.

The term “generated information” refers to output produced by a generative AI model based on a prompt sentence, including explanation information, recommendation information, summaries, or other natural-language content.

The term “user terminal” refers to an information processing device used by a user to receive information and provide input, such as a display unit, a mobile communication device, or an in-vehicle human-machine interface.

The term “interactive format” refers to a presentation mode in which information is displayed in a conversational or stepwise manner, allowing a user to view responses and provide follow-up input, including a chat-style interface.

The term “meeting index information” refers to index information generated from character information acquired during a meeting, the information associating agenda information, terminology information, and decision information with corresponding segments of the character information.

The term “agenda information” refers to information indicating topics, issues, or items to be discussed or discussed in a meeting, as identified from character information.

The term “terminology information” refers to information indicating technical terms, domain-specific terms, or frequently used expressions in a meeting, as identified from character information.

The term “decision information” refers to information indicating determinations, agreements, action items, or resolutions made during a meeting, as identified from character information.

The term “unknown expression” refers to an expression for which explanation information has not yet been stored or that is designated by a user or by the system as requiring explanation.

The term “autonomous mobile body” refers to a mobile platform capable of navigating without continuous human operation, such as an autonomous vehicle, robot, or other self-propelled unit.

The term “demand for food” refers to intent information indicating that a user is seeking eating or drinking opportunities, such as restaurants, cafes, or similar facilities.

The term “demand for sightseeing” refers to intent information indicating that a user is seeking recreational or cultural experiences, such as visiting landmarks, attractions, or events.

The term “demand for lodging” refers to intent information indicating that a user is seeking accommodation, such as hotels, inns, or other facilities for overnight stay.

The term “current position information” refers to information indicating a present geographic location of a mobile body or user, including coordinates, map data, or location identifiers.

The term “surrounding facility information” refers to location-related information describing facilities located within a region around a current position, including facility type, name, rating, distance, and attributes.

In one embodiment, a server implements the claimed system as a combination of hardware resources and software modules that cooperate to process acoustic information, generate structured index information, classify intent information, and construct prompt sentences for a generative AI model. The server uses a processor, a memory, and a storage device, and is connected to at least one electroacoustic transducer and at least one user terminal via a communication network.

The server uses the electroacoustic transducer, such as a microphone or microphone array installed in an autonomous vehicle cabin or a meeting room, to acquire acoustic information. The server converts analog signals from the electroacoustic transducer into a digital signal by using an audio interface, such as an analog-to-digital converter integrated on an in-vehicle computer. The server stores the digital signal in a buffer region of the memory in a time-stamped, frame-based data structure. For example, the server manages the digital signal as a sequence of fixed-length frames (e.g., 20-30 ms per frame) with associated time indices, which later allow the server to associate recognized character information with time stamps.

The server executes speech recognition processing on the digital signal to convert the digital signal into character information. In one configuration, the server uses a speech recognition engine implemented by a recurrent neural network or a transformer-based acoustic model in combination with a statistical or neural language model. As one example, the server may interface with a cloud-based speech-to-text service that internally uses a deep neural network trained on large speech corpora. The server sends buffered audio frames over a secure communication channel and receives, in response, recognized character information together with confidence scores and time alignment information. The server stores the character information in the storage device in association with session identifiers, time stamps, and speaker labels.

The server executes natural language processing on the character information to perform morphological analysis and syntactic analysis and to extract expressions. In one embodiment, the server uses a natural language processing library that implements tokenization, part-of-speech tagging, lemmatization, and dependency parsing. The server loads models for multiple languages, such as an English model and a Japanese model, into memory at initialization. The server applies these models to the character information to identify words, multi-word expressions, noun phrases, and named entities. The server computes part-of-speech tags and dependency relations and stores these as annotation fields in a structured representation. For example, the server manages each sentence as a record that contains token indices, token strings, part-of-speech tags, head indices, and dependency labels.

The server generates index information based on occurrence position information and occurrence frequency information of the extracted expressions and stores the index information in association with the character information in the storage device. In one configuration, the server maintains an inverted index data structure in a relational database or a search engine, where each entry links an expression to one or more positions in the character information. The server uses occurrence position information, such as sentence index, token offset, and time stamp, as keys for later retrieval. The server also calculates occurrence frequency information such as term frequencies per session or per time window and stores frequency values as numerical fields. The server optionally computes weighting factors such as TF-IDF values to prioritize expressions that are salient in the current session. By maintaining this structured index information, the server enables faster retrieval of relevant portions of the character information compared to a naive full-text search, thereby improving computational efficiency.

The server classifies intent information indicating a user interest item and a movement destination based on the character information. In one embodiment, the server uses a multi-class classification model, such as a neural network with an embedding layer, one or more transformer or recurrent layers, and a softmax output layer, trained to assign intent labels (e.g., food demand, sightseeing demand, lodging demand, information query) to short segments of character information. The server converts each segment (for example, one or two utterances) into a sequence of token embeddings using a pre-trained text encoder and feeds the embeddings into the classification model. The server uses a loss function such as cross-entropy during training and updates model weights with an optimization method such as stochastic gradient descent with momentum or an adaptive method. In deployment, the server applies the learned weights to incoming character information and outputs intent labels with confidence scores. The server stores the intent information along with the corresponding expressions and time stamps in a dedicated intent log, which later supports integration with location-related information.

The server specifies a target for assignment of location information based on the intent information and the index information and searches the storage device for location-related information corresponding to the target to acquire related information. In one example, when the server detects intent information indicating a demand for food and identifies expressions such as “ramen,” “sushi,” or “restaurant” from the index information, the server selects these expressions as targets for assignment of location information. The server then queries a location information database containing entries for facilities, each entry including geographic coordinates, category labels, and attributes such as rating, price range, and opening hours. The server may instead or additionally query an external map service via an application programming interface. The server uses current position information of an autonomous mobile body, such as an autonomous vehicle, to filter and rank facility candidates by distance and relevance to the intent information and the extracted expressions. The server precomputes or caches results for frequent combinations of location and intent to reduce communication load and latency.

The server generates a prompt sentence based on description request information including an expression selected by a user from among the character information and context information before and after the expression. The server records selection events received from a user terminal, including the selected expression, a character information segment containing the expression, and neighboring segments serving as context information. The server constructs the prompt sentence by inserting this information into a template designed for interaction with a generative AI model. For example, the server generates a prompt sentence of the form: “You are an in-vehicle assistant. The passenger conversation is: ‘We are visiting the city center for the first time and want to see historical temples near the river area.’ The key term is: ‘temples near the river area.’ Provide a concise, context-aware explanation and suggest three specific tourist spots related to this term.”

In another example, the server generates a prompt sentence for food-related intent: “You are an in-vehicle assistant. The passenger said they are hungry and want to eat ramen soon. Here are nearby ramen restaurants: [facility A: distance, rating, price range]; [facility B: distance, rating, price range]; [facility C: distance, rating, price range]. Recommend 3 options and explain briefly why they are good choices.”

The server uses program logic to ensure that the prompt sentence includes not only the selected expression and context information, but also structured data such as surrounding facility information, thus enabling the generative AI model to generate more precise and context-aware responses.

The server inputs the prompt sentence to a generative AI model and obtains generated information. In one configuration, the generative AI model is a transformer-based language model with multiple attention layers, feedforward layers, and positional encodings, trained on large-scale text corpora. During training, the model uses a token-level objective function such as next-token prediction and an error function such as cross-entropy, and updates model parameters using gradient-based optimization. The server calls the generative AI model through an inference interface that accepts tokenized prompt sentences and returns generated token sequences. The server controls generation parameters, such as maximum output length, temperature, and top-k or top-p sampling thresholds, to adjust diversity and determinism. The server filters generated information against defined criteria (e.g., length, prohibited terms) and stores the generated information together with the corresponding prompt sentence, so that repeated queries with the same context can reuse previous responses without re-invoking the model, which reduces computation and communication load.

The server integrates the related information acquired by search and the generated information acquired from the generative AI model and controls presentation of the integrated information in an interactive format to the user terminal. The server constructs a response object that includes structured fields (e.g., a list of facilities with coordinates and attributes) and unstructured fields (e.g., natural-language explanations or recommendations). The server sends this response object to the user terminal via a communication interface, such as a web application interface or a message-oriented protocol. The server also maintains state information about ongoing interactions so that follow-up prompt sentences can reference prior responses and preserve conversational context. This design allows the server to handle complex multi-turn dialogues while managing computational resources efficiently.

The terminal displays character information, index information, and integrated information to the user and receives user input. The terminal may be an in-vehicle display unit, a mobile communication device, or a workstation. The terminal renders a transcript view where character information is shown in time order, and highlights expressions that are registered in the index information. The terminal displays a list of extracted expressions, intent summaries, and facility candidates in separate panels or overlay windows. The terminal receives user selection events when the user taps or clicks an expression or a facility, and transmits corresponding selection data to the server. The terminal also displays generated information from the generative AI model in a chat-style interface, in which each response is presented as one or more turns of dialogue. The terminal may present route guidance or navigation confirmations in the case of an autonomous mobile body.

The user interacts with the system by speaking and by operating the user interface of the terminal. The user speaks natural language, such as “I'm getting hungry; I'd like to eat ramen soon” or “We are visiting this city for the first time and want to see historical temples near the river area.” The user views the automatically generated transcript and may select words such as “ramen” or “temples” to request further explanation. The user may also select one of several recommended facilities to initiate navigation or to obtain additional details. By permitting both voice-based and touch-based input, the system supports use in environments where manual input alone or voice input alone would be inconvenient.

From a technical standpoint, the server improves the functioning of the computer system beyond a mere automation of human tasks. By generating and maintaining index information that encodes occurrence position information and occurrence frequency information for extracted expressions, the server reduces the computational cost of subsequent retrieval operations. Instead of re-parsing entire transcripts or searching through raw character information, the server consults the index information to directly identify relevant segments, thereby decreasing processing time and memory consumption. By classifying intent information with a dedicated model and coupling the intent information to specific expressions in the index information, the server enables more accurate selection of targets for assignment of location information. This reduces the number of facility queries and the volume of data that must be transmitted over the network, improving communication efficiency.

The specific structure of the generative AI model and the prompt generation logic also contributes to technical improvements. The server uses a transformer-based neural network model whose parameters have been trained using large-scale gradient-based optimization, enabling the system to handle complex linguistic patterns that rule-based systems cannot easily capture. The server does not simply pass arbitrary text to the model; instead, the server programmatically constructs prompt sentences that incorporate context information, intent information, and surrounding facility information in a specific, non-conventional template. This template design ensures that the generative AI model receives enough structured and contextual information to produce concise, relevant, and well-targeted responses, thereby increasing precision and reducing the need for repeated queries and corrections. The server thus reduces the number of interaction rounds required to obtain a satisfactory response, which lowers computation and latency.

In one variation, the server applies an additional ranking layer between the generative AI model and the user terminal. The server calculates numerical scores representing the alignment between generated information and the index information or intent information, for example by computing cosine similarity between vector embeddings of expressions and generated sentences. The server uses these scores to filter and arrange generated information before transmitting it to the terminal. This arrangement further reduces the amount of data sent to the terminal and improves the clarity and compactness of displayed information.

In another embodiment, the server adapts its models using feedback data. When the user frequently selects certain kinds of facilities or repeatedly requests clarification about particular expressions, the server logs these events and updates parameters of the intent classification model or adjusts prompt sentence templates to emphasize the user's typical preferences. The server may apply offline retraining with new data or use online learning methods that modify a subset of parameters. The server records such updates in a versioned model repository, ensuring reproducibility and enabling rollback if performance degrades.

In a further embodiment, the server supports both in-vehicle use and meeting-room use. In a meeting scenario, the server receives acoustic information from multiple microphones and forms character information representing multiple speakers. The server generates meeting index information that associates agenda information, terminology information, and decision information with corresponding segments of the character information. When a user at a terminal selects an unknown expression or a topic such as “budget forecast” or “release schedule,” the server constructs a prompt sentence that instructs the generative AI model to summarize or explain all occurrences of that topic. For example, the server may generate a prompt sentence: “Using the following meeting transcript excerpts about ‘release schedule,’ summarize the key decisions and open issues in no more than five sentences.”

By using the structured meeting index information, the server can extract only the relevant segments of the transcript and provide a compact, technically accurate summary, thereby reducing computational effort and improving the usefulness of the output for participants.

Because the server ties each processing stage to explicit data structures—audio frame buffers, annotated sentence records, inverted index tables, intent logs, and facility tables—the system provides a concrete and repeatable implementation that can be realized by one skilled in the art. The combination of these structures and the specific sequence of analysis, indexing, classification, and generative prompt construction yields measurable improvements in processing speed, retrieval accuracy, and network efficiency. Therefore, the system operates as an improvement to underlying computer technology itself, rather than merely automating an existing human workflow.

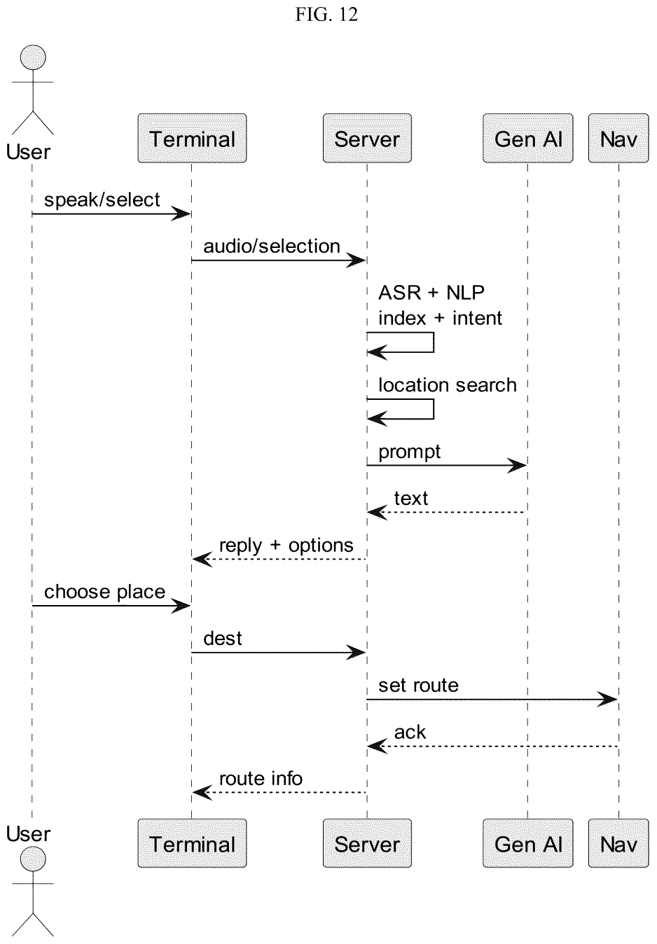

The following describes the processing flow using FIG. 12.

### Step 1

Server acquires acoustic information.

Server receives analog audio signals from an electroacoustic transducer installed in an autonomous mobile body or a meeting room. The input is a continuous analog waveform representing user speech and ambient sound. Server uses an audio interface to sample the waveform at a predetermined sampling frequency and converts the waveform into a digital signal composed of timestamped audio frames. Server stores the digital signal in a circular buffer in memory, thereby transforming unstructured analog sound into time-discrete numerical data suitable for subsequent computation.

### Step 2

Server converts the digital signal into character information.

Server reads a sequence of audio frames from the buffer as input to a speech recognition engine. Server performs feature extraction, such as computing Mel-frequency cepstral coefficients or log-mel spectrograms, and feeds the features into an acoustic model. Server combines acoustic model outputs with a language model to infer a most probable character sequence. The input is the digital signal, and the output is character information, including recognized text, confidence scores, and time alignment information. Server stores each recognized utterance as a record with fields for session identifier, start time, end time, and text.

### Step 3

Server executes natural language processing and extracts expressions.

Server takes the character information as input and applies a natural language processing pipeline. Server tokenizes sentences into tokens, assigns part-of-speech tags, and performs morphological analysis to determine lemmas and inflectional features. Server then performs syntactic analysis, such as dependency parsing, to identify grammatical relations between tokens. Based on these annotations, server extracts expressions, such as noun phrases, named entities, and domain-relevant multi-word terms. The output is a set of expression objects, each including a string value, token indices, sentence index, and linguistic attributes.

### Step 4

Server generates index information based on occurrence positions and frequencies.

Server uses the expression objects and their associated positions in the character information as input. Server creates or updates an inverted index data structure that maps each expression to a list of occurrence entries. Each occurrence entry contains occurrence position information, such as sentence index, token offset, and time stamp. Server also computes occurrence frequency information by counting how many times each expression appears in the current session and optionally across multiple sessions. The output is index information stored in a storage device, including, for each expression, a list of positions and frequency values, enabling efficient retrieval by expression.

### Step 5

Server classifies intent information.

Server receives recent segments of character information and associated expressions as input. Server converts each segment into a sequence of numeric vectors using a text embedding method and feeds the vectors into an intent classification model. Server applies matrix multiplications, non-linear activation functions, and attention mechanisms to compute intent probabilities for categories such as food demand, sightseeing demand, lodging demand, or generic information query. Server selects the intent with the highest probability exceeding a threshold and outputs intent information, including intent label and confidence score. Server stores the intent information in an intent log linked to the corresponding expressions and time stamps.

### Step 6

Server specifies a target for assignment of location information.

Server takes the intent information and the index information as input. When the intent indicates a location-related need, server filters expressions in the index information to find those that are semantically related to places, categories, or activities, such as “restaurant,” “museum,” or “hotel.” Server may use rule-based matching or additional similarity calculations between expression embeddings and category vectors. Server selects one or more expressions as targets for assignment of location information. The output is a list of target expressions, each associated with the relevant intent information.

### Step 7

Server acquires location-related information.

Server receives the target expressions and current position information of the autonomous mobile body as input. Server constructs one or more queries specifying category filters, keyword filters, and geographic constraints. Server sends these queries to a local facility database or an external map service and receives facility records that match the conditions. Server computes distances from the current position to each facility, sorts facilities by distance, rating, or relevance to the target expressions, and filters out facilities that do not meet predefined criteria, such as opening hours. The output is related information, including a ranked list of surrounding facilities with attributes such as coordinates, type, rating, and description.

### Step 8

Terminal displays transcript and indexed expressions to the user.

Terminal receives character information and index information from the server as input. Terminal renders a transcript view, placing sentences in temporal order and annotating each sentence with a time stamp. Terminal highlights tokens corresponding to expressions in the index information using visual markers, such as underlines or color changes. Terminal also displays a panel listing extracted expressions and, optionally, associated intents. The output is a graphical user interface in which the user can see both the recognized speech and the system's identified key expressions.

### Step 9

User selects an expression or requests additional information.

User observes the transcript and highlighted expressions on the terminal. User selects an expression by touching, clicking, or otherwise operating the terminal interface, or by issuing a voice command referencing the expression. The input to the terminal is the user's selection action. Terminal converts this action into selection data that includes the selected expression, its position in the character information, and an identifier of the session. Terminal sends this selection data to the server as a request for explanation information or recommendation information. The output is a structured selection message transmitted to the server.

### Step 10

Server constructs description request information and context information.

Server receives the selection message as input. Server retrieves context information by loading sentences or utterances immediately preceding and following the selected expression from the storage device. Server aggregates the selected expression, the surrounding sentences, and any associated intent information into description request information. Server structures the description request information as a data object containing fields for expression text, context text, time range, and intent label. The output is a context-rich description request object that represents the user's information need.

### Step 11

Server generates a prompt sentence for the generative AI model.

Server takes the description request information, the related information, and the intent information as input. Server inserts these elements into a prompt template selected according to the intent type. Server concatenates instruction text, context text, selected expression, and structured facility data into a single prompt sentence string. For example, server generates a prompt sentence such as:
“You are an in-vehicle assistant. The passenger said they are hungry and want to eat ramen soon. Here are nearby ramen restaurants: [facility A: distance, rating, price range]; [facility B: distance, rating, price range]; [facility C: distance, rating, price range]. Recommend 3 options and explain briefly why they are good choices.”

As another example, server generates a prompt sentence such as: “You are an in-vehicle assistant. The passenger conversation is: ‘We are visiting the city center for the first time and want to see historical temples near the river area.’ The key term is: ‘temples near the river area.’ Provide a concise, context-aware explanation and suggest three specific tourist spots related to this term.”

The output is a prompt sentence string ready to be supplied to the generative AI model.

### Step 12

Server inputs the prompt sentence to the generative AI model and obtains generated information.

Server tokenizes the prompt sentence as input and converts tokens into embeddings using an embedding matrix of a transformer-based language model. Server processes the embeddings through multiple attention layers and feedforward layers, applying learned weights and activation functions to compute probability distributions over possible next tokens. Server iteratively samples or selects tokens according to configured decoding parameters until an end-of-sequence condition is met. The input is the prompt sentence, and the output is generated information, such as explanation text or recommendation text. Server post-processes the generated information by removing undesired tokens and ensuring the generated content length and format meet predefined constraints.

### Step 13

Server integrates generated information with related information.

Server receives the generated information and the related information as input. Server constructs an integrated response object that combines the facility list or other related information with the natural-language explanation or recommendation produced by the generative AI model. Server may compute an alignment score between generated sentences and facility attributes to order or group sentences near corresponding facilities. Server formats the integrated response into a structure suitable for presentation, including sections for summary, detailed explanations, and selectable facility entries. The output is an integrated response message that the server transmits to the terminal.

### Step 14

Terminal presents integrated information in an interactive format.

Terminal receives the integrated response message as input. Terminal displays the generated explanation or recommendation in a chat-style interface, showing each response as a separate message. Terminal simultaneously displays related information, such as a list of surrounding facilities or a map view with markers, allowing the user to select entries for more details. Terminal may provide interactive controls, such as buttons to set a selected facility as a destination. The output is an updated graphical user interface through which the user can understand the system's suggestions and take further actions.

### Step 15

User issues follow-up actions or confirms a destination.

User reads the explanation and recommendation on the terminal and chooses an action, such as requesting more details about a specific facility, asking an additional question by voice or text, or confirming one facility as the destination. The input to the terminal is the user's follow-up operation. Terminal encodes the follow-up operation into a request message and sends it to the server, which may re-enter the processing flow, generate a new prompt sentence, and obtain updated generated information. The output is a continuation of the interactive session, driven by user-initiated input.

### Step 16

Server controls external devices based on user selection.

Server receives a confirmation indicating that the user has selected a specific facility as a destination. Server takes as input the facility's geographic coordinates and the identifier of the autonomous mobile body. Server sends a control command, including the destination coordinates, to a navigation module or vehicle control unit using an in-vehicle communication interface. Server waits for an acknowledgment from the navigation module and then generates a status message indicating successful route setup. The output is a control effect in the physical world, namely, updating the planned route of the autonomous mobile body and notifying the terminal of the new navigation status.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional meeting-support and transcription systems typically convert speech to text and, at most, allow keyword search over the resulting transcript. Such systems are largely context-agnostic: they treat words as isolated tokens and do not analyze the evolving conversational context in which those words appear. As a result, these systems cannot reliably determine which terms are important at a given moment, cannot distinguish between different senses of the same term, and cannot automatically generate explanations that are tailored to the current topic and the knowledge level of the participants.

Moreover, when a user encounters an unknown word during a meeting or dialogue, existing systems generally require the user to interrupt the workflow, manually perform a search operation, and then sift through unrelated results. This introduces latency and cognitive overhead, and can cause participants to miss subsequent parts of the conversation. Existing architectures also do not provide efficient mechanisms for maintaining a structured index that links extracted words to their local and global conversational context, nor do they provide a standardized way to dynamically construct and refine input prompts for a generative artificial intelligence model based on such context.

From the standpoint of computer technology, there is therefore a need for improved data processing techniques and system architectures that (i) integrate real-time speech recognition, natural language processing, and generative artificial intelligence in a unified processing pipeline, (ii) maintain and update a context-sensitive index of words and surrounding text data as a machine-processable data structure, and (iii) algorithmically construct prompt sentences for a generative artificial intelligence model using computed context information, rather than relying on fixed, manually authored prompts. Without such improvements, the computational resources of modern generative models are under-utilized, response generation cannot be reliably aligned with the user's actual conversational context, and the latency and interaction costs for retrieving explanatory information remain high.

Accordingly, the technical problem to be solved by the invention is to improve computer-implemented processing for real-time meeting and dialogue support by enabling a processor to automatically (a) capture speech, (b) convert the speech into structured text and index data, (c) derive machine-interpretable context information for selected words, and (d) generate, based on that context information, prompt sentences for a generative artificial intelligence model so that context-appropriate explanatory or detailed information can be generated and displayed with reduced latency and improved relevance. This addresses a concrete problem in computer technology: how to transform raw audio input into context-aware prompt sentences and responses through coordinated, algorithmic processing steps, thereby improving the efficiency, accuracy, and usefulness of human-computer interaction in real-time communication environments.

The specific processing by the specific processing unit 290 of the data processing device 12 in Example 2 is realized by the following means.

The present invention provides a server comprising a processor configured to use an acoustic input device to acquire audio information representing speech, convert the acquired audio information into a time-series digital signal based on a predetermined sampling condition, execute speech recognition processing using the digital signal as an input to sequentially generate character string data corresponding to the audio information, and store the character string data as text data in units of utterances or conversations; apply a natural language processing algorithm to the text data to perform morphological analysis and part-of-speech analysis to extract words, generate index information indicating a correspondence between each extracted word and text data including the extracted word, and store the index information in a search data structure; control an information display device to display the extracted words so that the extracted words are selectable, receive a selection operation of a specific word from a user, and acquire the selected word and text data located around the selected word; execute context analysis processing using the selected word and the surrounding text data as an input to generate context information indicating a semantic domain and a topic content in which the selected word is used; generate a prompt sentence to be input to a generative processing algorithm by combining the context information and the selected word with template information, input the prompt sentence to a generative artificial intelligence model that executes the generative processing algorithm, and acquire answer text data generated by the generative artificial intelligence model; and control the information display device to visually display the answer text data and to present, in real time during progress of a conversation, explanation information or detailed information related to the selected word. This enables a computer system to transform raw audio signals into structured, context-indexed text data, to algorithmically derive and represent conversational context for user-selected words, and to automatically construct and supply context-aware prompt sentences to a generative artificial intelligence model, thereby improving the technical performance of real-time information retrieval and explanation generation in meeting and dialogue environments, reducing interaction latency, and enhancing the relevance and usefulness of generated responses.

The term “processor” refers to a hardware or virtual computation unit, such as a central processing unit or a general-purpose processing core, configured to execute machine-readable instructions to perform data processing operations as described herein.

The term “acoustic input device” refers to an input apparatus, such as a microphone or microphone array, configured to receive sound waves and convert the sound waves into corresponding electrical or digital audio signals.

The term “audio information” refers to data representing sound, including speech uttered by a user during a meeting or dialogue, in analog or digital form.

The term “time-series digital signal” refers to a sequence of digital values sampled at discrete time intervals according to a predetermined sampling condition, representing the temporal evolution of an audio waveform.

The term “predetermined sampling condition” refers to acquisition parameters, such as sampling frequency, bit depth, and channel configuration, that define how analog audio is converted into digital form.

The term “speech recognition processing” refers to computational operations that analyze an audio signal and identify linguistic content, thereby converting the audio signal into corresponding text data.

The term “character string data” refers to digital data representing a sequence of characters that encode linguistic units, such as words, sentences, or utterances.

The term “text data” refers to structured or semi-structured data composed of one or more character strings representing linguistic content derived from speech.

The term “utterance” refers to a segment of speech, such as a sentence or phrase, produced continuously by a speaker without an extended pause.

The term “conversation” refers to a series of utterances exchanged among one or more participants over a time span in a meeting or dialogue session.

The term “natural language processing algorithm” refers to a computational procedure that analyzes text expressed in a human language to determine linguistic or semantic properties, such as tokenization, part-of-speech tagging, or semantic labeling.

The term “morphological analysis” refers to processing that segments text into tokens and determines internal structure, such as stems, affixes, and base forms of words.

The term “part-of-speech analysis” refers to processing that assigns grammatical categories, such as noun, verb, or adjective, to tokens in text.

The term “word” refers to a linguistic unit extracted from text, represented as a token or string, that may correspond to a lexeme or term.

The term “index information” refers to structured data that associates an extracted word with one or more occurrences of that word in text data, including information indicating positions or contexts of the occurrences.

The term “search data structure” refers to a data organization, such as a table, list, tree, or inverted index, that enables efficient retrieval of entries based on keys, such as words or identifiers.

The term “information display device” refers to an output apparatus, such as a display screen or graphical user interface component, configured to present visual information to a user.

The term “selection operation” refers to an input action, such as a tap, click, or other user interaction, by which a user indicates a particular item, such as a displayed word, to be chosen.

The term “surrounding text data” refers to text content that is located before, after, or near a selected word in a transcript or conversation, and that provides contextual information for the selected word.

The term “context analysis processing” refers to computational operations that analyze a selected word and its surrounding text data to determine semantic properties, usage conditions, and topical relationships.

The term “context information” refers to data representing semantic and situational characteristics associated with a selected word, including at least a semantic domain and topic content in which the selected word is used.

The term “semantic domain” refers to a conceptual category or field of meaning, such as technology, finance, or medicine, to which a word or phrase belongs in a given context.

The term “topic content” refers to subject matter or themes discussed in association with a selected word, as inferred from surrounding text data in a conversation.

The term “template information” refers to predefined text patterns or structures that provide a framework into which variable elements, such as a selected word and context information, are inserted to form a prompt sentence.

The term “prompt sentence” refers to a natural-language text string generated according to template information and context information and intended to be supplied as input to a generative processing algorithm or generative artificial intelligence model.

The term “generative processing algorithm” refers to a computational procedure implemented by a generative model to produce output content, such as text, based on input data including a prompt sentence.

The term “generative artificial intelligence model” refers to a machine-learned model, such as a neural network model, configured to generate new content, including text, from input data, such as a prompt sentence and optional conditioning information.

The term “answer text data” refers to text output generated by the generative artificial intelligence model in response to a prompt sentence, representing explanation information, detailed information, or other content.

The term “explanation information” refers to answer text data that provides a definition, description, or clarification of a selected word or concept.

The term “detailed information” refers to answer text data that provides additional elaboration, such as use cases, examples, or technical details, related to a selected word or topic.

The term “unknown word” refers to a word that is determined by the processor to be unfamiliar or not previously known to the user or to fall outside a predefined vocabulary or knowledge state.

The term “definition information” refers to explanation information that specifies the meaning of a word or term in a concise and explicit manner.

The term “usage-example information” refers to information that illustrates how a word or term is used in context, for example by providing example sentences or scenarios.

The term “meeting session” refers to a defined time period during which participants engage in structured or semi-structured discussion, and during which speech is captured and processed by the system.

The term “dialogue session” refers to an interactive exchange of utterances between one or more participants and the system, or among participants, treated as a continuous conversational unit for processing.

The term “latest context information” refers to the most recently computed context information for a meeting session or dialogue session, reflecting current conversational state, topics, and semantic relationships.

In one embodiment, a server, a terminal, and a user cooperate to implement the invention.

The server includes at least one processor, a memory, a non-volatile storage device, a network interface, and an acoustic input device such as a microphone or a microphone array. The terminal includes a processor, a memory, a display device, a user input interface such as a touch panel, and a communication interface. The server and the terminal communicate over a communication network such as a wired or wireless packet network.

The server stores, in the non-volatile storage device, a set of software modules including an operating system, a speech recognition module, a natural language processing module, an index management module, a context analysis module, a prompt generation module, and a generative artificial intelligence interface module. The server loads these modules into the memory and causes the processor to execute them. In one example, the speech recognition module uses a general speech recognition engine implemented on a server-class machine, such as an engine compatible with widely used cloud-based speech recognition services or on-premise engines. The natural language processing module uses a natural language processing library such as a library configured to perform tokenization, morphological analysis, and part-of-speech tagging. The natural language processing module can use a transformer-based language representation model, such as a bidirectional encoder model, implemented by a library for neural language models. The generative artificial intelligence interface module communicates with a generative AI model deployed either as a remote service or as a local model, for example a transformer-based text generation model stored on the server and executed on graphics processing units.

The server uses the acoustic input device to capture analog audio signals representing speech uttered by the user, and the processor converts the analog signals into digital audio data based on predetermined sampling conditions, for example a sampling rate of 16 kHz, a fixed bit depth, and a single audio channel. The server stores the digital audio data in a circular buffer structure in the memory. By employing a circular buffer, the server maintains a fixed-size, continuously updated representation of the most recent portion of the meeting, which reduces memory usage and avoids repeated dynamic memory allocations, thereby improving processing efficiency.

The server executes the speech recognition module to transform the digital audio data into character string data representing text. The speech recognition module applies acoustic feature extraction, such as short-time Fourier transform or Mel-frequency cepstral coefficients, to the audio samples, and then applies a trained acoustic model and a language model to map audio features to sequences of subword units or characters. The speech recognition module outputs character sequences along with timing and confidence scores. The server aggregates these sequences into text data units corresponding to utterances or conversation segments and stores the text data in the storage device. The text data is stored in association with metadata such as time stamps, utterance identifiers, and speaker identifiers, using a structured data model, for example a table schema or a document schema. This structured storage allows the server to retrieve and update transcript segments with low latency.

The server executes the natural language processing module on the text data. The natural language processing module segments the text data into tokens, assigns part-of-speech tags, and identifies base forms of words. The server extracts words considered important based on rules or statistical measures, such as selection of nouns, technical terms, and named entities, and based on term frequency within the meeting. The server constructs index information that associates each selected word with a list of occurrence records. Each occurrence record includes at least a token position, a sentence identifier, and references to surrounding text. The server stores this index information in a search data structure such as an inverted index or a hash-based map, maintained in memory or in a database. This specific data structure design enables the processor to respond rapidly to user selections, because the server can locate all contexts containing a selected word by a single key lookup, without scanning the full transcript.

The terminal receives, from the server, a subset of the text data and index information suitable for display. The terminal's processor executes an application program that renders a transcript view and a list or highlight of important words on the display device. The terminal displays the words as selectable objects, for example by underlining or emphasizing them, and associates each display object with an identifier of the corresponding word and its index entry. The user interacts with the terminal by touching or clicking on one of the words. The terminal detects this selection and transmits to the server the identifier of the selected word, as well as any locally cached surrounding text data.

Upon receiving a selected word, the server executes the context analysis module. The context analysis module retrieves, from the search data structure, the surrounding text data associated with the selected word, including at least one sentence before and after each occurrence and optionally additional transcript history from the beginning of the meeting. The context analysis module encodes the surrounding text using a neural embedding model. In one example, the context analysis module uses a transformer encoder network with multiple self-attention layers. The encoder maps token sequences into vector representations in a high-dimensional space. The server utilizes these vector representations as feature vectors that capture semantic and syntactic relationships between the selected word and its context.

The server computes a semantic domain and topic content for the selected word by comparing the feature vectors to reference vectors representing known domains and topics, or by passing the feature vectors through a classifier neural network trained to output domain and topic categories. The classifier network can be trained using supervised learning on labeled conversational data. Training is performed by defining a loss function, such as cross-entropy loss between predicted categories and ground-truth labels, and updating the network weights via gradient descent. The training process uses stochastic gradient descent or a variant, such as Adam optimization, to iteratively adjust weights so as to minimize the loss. Through this training process, the context analysis module learns patterns in feature vectors that correspond to particular semantic domains and topics, enabling the server to distinguish, for example, between a term used in a technical sense and the same term used in a casual sense.

The server stores the computed context information, including semantic domain and topic content, in association with the selected word and the conversation segment. The server then executes the prompt generation module. The prompt generation module maintains a set of template structures for different explanation types, such as definition-oriented templates, use-case-oriented templates, and comparison-oriented templates. Each template specifies a pattern for constructing a prompt sentence, including placeholders for the selected word, semantic domain, topic content, and instruction phrases.

The server fills the template placeholders using the selected word and the context information. For example, the server can generate a prompt sentence such as:
“Explain AI (artificial intelligence) in Japanese in a simple way for non-expert participants in a meeting. Include a short definition and one real-world example.”

In another example, where the context indicates that the selected word relates to customer support, the server can generate a prompt sentence such as:
“In the context of a company considering AI for its customer support system, explain what AI (artificial intelligence) is and how it can improve response time and customer satisfaction. Answer in Japanese and keep the explanation concise.”

By dynamically populating these templates using computed context information, the server generates prompt sentences that are closely aligned with the ongoing conversation and the user's informational needs. This dynamic construction is not limited to fixed, manually defined prompts; instead, it uses algorithmically computed context features, thereby improving the relevance and precision of downstream generative processing.

The server transmits the generated prompt sentence to a generative AI model. In one embodiment, the generative AI model is a transformer-based autoregressive text generation model comprising multiple attention layers and feed-forward layers, parameterized by a large number of weights. The model receives the prompt sentence as a sequence of token identifiers and computes output token probabilities by applying matrix multiplications and non-linear activation functions in each layer. The server controls model parameters such as temperature and maximum output length to regulate diversity and size of the generated answer. The generative AI model is trained in advance using large text corpora, with a training objective of predicting the next token given previous tokens. Training uses a loss function, such as token-level cross-entropy loss, and gradient-based optimization to update model weights. In some embodiments, the server performs additional fine-tuning of the generative AI model on domain-specific conversational data so that the model's outputs are adapted to meeting and dialogue contexts.

The server obtains, from the generative AI model, answer text data corresponding to the prompt sentence. The server can apply post-processing operations such as truncation, formatting, or filtering of irrelevant segments. The terminal receives the answer text data and displays it alongside the transcript or in a dedicated explanation area. The user reads the explanation while the meeting continues, without switching applications or performing separate search operations.

This architecture and processing sequence provide several technical effects. The server's use of a structured index and context-aware feature extraction reduces the amount of text that must be transmitted and processed for each user selection, thereby reducing communication load and total computation time. Because the server restricts generative processing to contexts identified as relevant by the context analysis module, the generative AI model is not invoked on large, unfiltered portions of the transcript, which improves computational efficiency and reduces latency.

The use of neural embedding and classifier models in the context analysis module improves the accuracy of identifying the semantic sense of a word, compared to simple keyword matching. This reduces the generation of irrelevant or incorrect explanations, thereby reducing error rates perceived by the user. The dynamic prompt generation module converts the context information into structured prompt sentences that guide the generative AI model toward generating responses targeted to the actual conversational state, which increases the usefulness of the generated answers. By updating the index and context information in real time as the meeting progresses, the server provides up-to-date context for each newly selected word, improving temporal accuracy and avoiding stale or mismatched explanations.

In another embodiment, the server deploys the generative AI model locally on a hardware accelerator, such as a graphics processing unit or a dedicated neural processing unit. The server stores the model parameters in the storage device and loads them into accelerator memory. The server controls data transfer between main memory and accelerator memory using optimized batch sizes and sequence lengths so that matrix multiplication operations can be performed efficiently. This configuration reduces external network dependency and latency, and allows the server to provide explanations even in constrained network environments.

In yet another embodiment, the terminal itself executes a lightweight speech recognition module and natural language processing module, and transmits only recognized text and selected indices to the server. In this case, the server performs mainly context analysis and generative processing. This division of labor reduces network bandwidth requirements because audio data does not need to be transmitted continuously. At the same time, the terminal's local processing offloads some computation from the server, allowing multiple terminals to be served concurrently with reduced server load.

The system achieves technical improvements beyond mere automation of human tasks. Human participants cannot, in real time, maintain a complete and searchable index of all words in an ongoing meeting, compute vector embeddings for each context, and dynamically construct optimized prompt sentences for a generative model. The server, by implementing specific data structures and algorithms, performs these operations at machine speed and scale, enabling instantaneous retrieval and tailored generation. This results in faster response times, better use of hardware resources, and improved accuracy of context-aware explanations compared with conventional systems that only record or transcribe speech.

Furthermore, by providing multiple embodiments, including different model architectures, different index structures, and different allocations of functions between server and terminal, the invention can be implemented under various hardware and software constraints while still preserving the essential technical features: real-time speech-to-text transformation, context-sensitive indexing, algorithmic context analysis, and dynamic construction of prompt sentences for a generative AI model, all of which contribute to improved computer performance in real-time meeting and dialogue support.

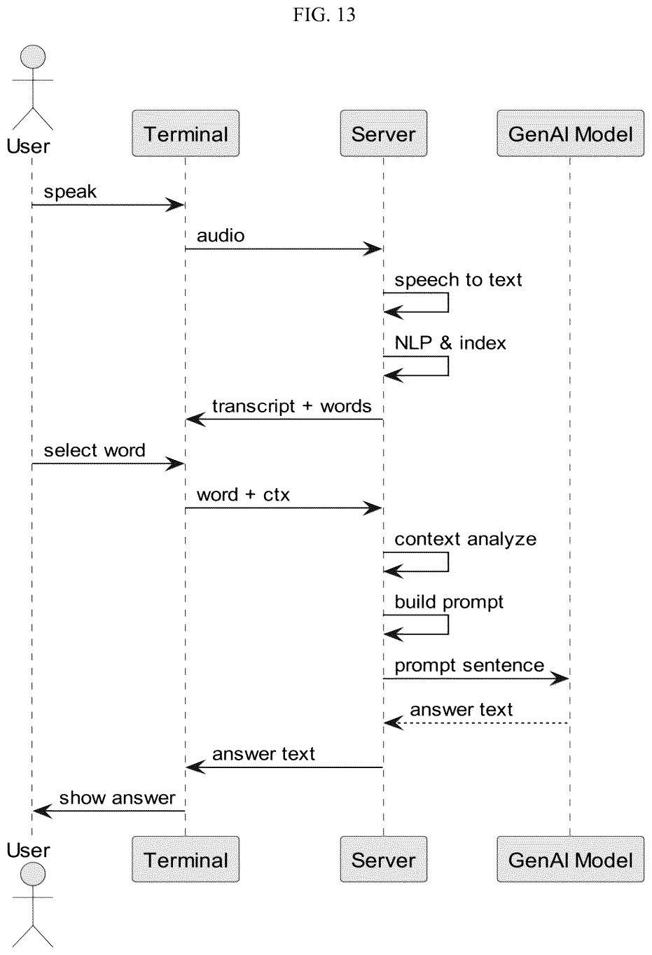

The following describes the processing flow using FIG. 13.

### Step 1

The user utters speech during a meeting or dialogue while using the terminal.

The input is human speech in the form of an analog acoustic signal, and there is no digital output yet.

The user produces continuous utterances, including words that may be unknown or require clarification.

### Step 2

The terminal acquires the analog acoustic signal through an acoustic input device and converts it into digital audio data.

The input is the analog audio waveform, and the output is a time-series digital signal such as 16-kHz, 16-bit, mono PCM samples.

The terminal samples the analog signal at predetermined intervals, quantizes each sample to a numeric value, and stores the resulting sequence in a buffer in memory.

### Step 3

The terminal transmits the digital audio data to the server over a communication network.

The input is buffered digital audio data with associated metadata such as session identifier and timestamps, and the output is one or more network packets containing the audio data delivered to the server.

The terminal encapsulates the audio data into request messages, attaches metadata headers, and sends the messages via a communication protocol such as HTTPS to the server's network interface.

### Step 4

The server receives the digital audio data and performs pre-processing for speech recognition.

The input is the digital audio data received from the terminal, and the output is normalized audio data suitable for the speech recognition module.

The server decodes any compression, adjusts sampling rate and channel configuration if necessary, normalizes amplitude, and writes the normalized audio frames into an internal processing buffer.

### Step 5

The server executes speech recognition processing to generate text data from the normalized audio data.

The input is the normalized time-series digital signal, and the output is character string data representing recognized words and sentences.

The server computes acoustic features for each frame, applies an acoustic model and language model to infer a most likely token sequence, and concatenates recognized tokens into text segments associated with timestamps.

### Step 6

The server aggregates the recognized character string data into utterance-level or conversation-level text data units and stores them.

The input is a stream of recognized character strings with timestamps, and the output is structured text data records stored in a transcript data structure.

The server groups tokens into sentences based on pause duration and punctuation, assigns utterance identifiers, and writes the grouped text records along with metadata into a storage device.

### Step 7

The server applies a natural language processing algorithm to the stored text data to extract words and linguistic annotations.

The input is the text data representing the transcript, and the output is a set of tokens with associated features such as part-of-speech tags and base forms.

The server segments the text into tokens, assigns grammatical categories to each token, computes lemmas, and identifies candidate important words based on rule-based or statistical criteria.

### Step 8

The server generates index information that maps each extracted word to its occurrences in the text data.

The input is the set of extracted words with positional information, and the output is index information stored in a search data structure such as an inverted index.

The server creates entries that, for each word key, list occurrence records containing text identifiers, token offsets, and surrounding sentence references, and inserts these entries into the search data structure for efficient retrieval.

### Step 9

The server transmits display data including the transcript and extracted words to the terminal.

The input is the text data and associated index information, and the output is a formatted data structure suitable for rendering on the terminal.

The server selects relevant text segments and important words, encodes them into a structured response, and sends this response to the terminal via the network interface.

### Step 10

The terminal displays the transcript and the extracted words so that the words are selectable by the user.

The input is the formatted display data received from the server, and the output is a graphical user interface showing the text and selectable word elements on the display device.

The terminal renders each important word as a distinct interactive element, associates it with an internal identifier, and updates the screen so the user can select a word with a touch or click.

### Step 11

The user selects a specific word on the display when additional explanation is desired.

The input is the graphical user interface showing selectable words, and the output is a selection event indicating which word has been chosen.

The user touches or clicks on the displayed word, causing the terminal to generate an event that specifies the word identifier, its position in the transcript, and any current UI context.

### Step 12

The terminal transmits the selected word information and surrounding text data to the server.

The input is the selection event and locally stored surrounding text data, and the output is a request message delivered to the server containing the selected word and context.

The terminal packages the word identifier, the sentence or sentences around the word, and session metadata into a request, and sends this request via the communication interface to the server.

### Step 13

The server retrieves additional surrounding text data and index information for the selected word.

The input is the selected word identifier and initial surrounding text data, and the output is an extended context text block and associated index entries.

The server performs a lookup in the search data structure using the word as a key, fetches all matching occurrence records, and collects neighboring sentences and prior conversation history to build a comprehensive context window.

### Step 14

The server executes context analysis processing to derive context information for the selected word.

The input is the extended context text block and occurrence records, and the output is context information including at least a semantic domain and topic content.

The server encodes the text using a context encoder, such as a transformer-based embedding model, computes vector representations for sentences and the selected word, and applies a classifier or similarity computation to categorize the semantic domain and to identify the main topic discussed around the selected word.

### Step 15

The server determines whether the selected word should be treated as an unknown word for the user.

The input is the context information for the selected word and optionally user preference data or prior interaction history, and the output is a decision flag indicating whether the word is unknown and requires a definitional explanation.

The server compares the selected word against a known-term list, evaluates previously generated explanations for the same word, and can check domain-specific difficulty levels to decide whether a definition and usage example should be requested from the generative AI model.

### Step 16

The server generates a prompt sentence for the generative AI model based on the context information and the unknown-word decision.

The input is the selected word, the context information, and the decision flag, and the output is a prompt sentence tailored to request an appropriate explanation or detailed information.

The server selects a template corresponding to a definition request, a use-case request, or another explanation type, fills placeholders with the selected word, semantic domain, topic description, and instruction phrases, and concatenates these components into a coherent natural-language prompt sentence, such as:
“Explain AI (artificial intelligence) in Japanese in a simple way for non-expert participants in a meeting. Include a short definition and one real-world example.”

### Step 17

The server supplies the generated prompt sentence to the generative AI model and obtains answer text data.

The input is the prompt sentence, and the output is answer text data generated by the generative AI model.

The server tokenizes the prompt sentence, feeds the token sequence into the generative AI model, receives output tokens representing the model's response, and converts the tokens back into a character string that forms the answer text.

### Step 18

The server post-processes the answer text data and prepares it for display on the terminal.

The input is the raw answer text data from the generative AI model, and the output is refined answer text suitable for user presentation.

The server may remove redundant phrases, apply length limits, insert simple formatting markers, and associate the answer with the original selected word and timestamp before encapsulating it in a response message.

### Step 19

The server transmits the refined answer text to the terminal.

The input is the refined answer text and associated metadata, and the output is a response delivered over the network to the terminal.

The server constructs a response message including the answer text and identifiers linking it to the selected word, and sends this message through the network interface to the terminal.

### Step 20

The terminal displays the answer text to the user in association with the selected word.

The input is the response message containing the answer text and word identifiers, and the output is an updated graphical user interface presenting the explanation or detailed information.

The terminal locates the UI element corresponding to the selected word, inserts or overlays the answer text near that element or in a dedicated explanation pane, and refreshes the display so that the user can read the generated explanation while the meeting continues.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional dialogue and search systems executed on general-purpose computer hardware typically treat speech recognition, text indexing, and response generation as loosely coupled or offline processes. Audio is often transcribed in bulk, and separate indexing engines later build keyword lists without tight temporal alignment or contextual understanding of an ongoing conversation. When a user issues an information request during a live meeting or interactive session, the computer system generally performs a simple keyword search against pre-built indexes or static knowledge bases. Such approaches do not exploit the full conversational context, including the temporal position of utterances, surrounding text, or the user's evolving intent. As a result, these systems frequently return overbroad, non-contextual, or delayed responses, forcing the user to manually refine queries and interrupt the workflow.

Further, existing systems do not treat the construction and use of prompt sentences for generative AI models as a first-class, system-level computation. Instead, prompts are often hand-authored or statically defined, which prevents the computing system from leveraging real-time transcript data and index structures when formulating queries to a generative AI model. This leads to inefficient use of processing resources and network bandwidth, as large, unstructured context blocks may be transmitted, and the generative AI model may be required to infer user intent from noisy inputs. The lack of a structured, programmatic pipeline for building prompt sentences tied to indexed transcript data degrades both the quality of generated responses and the responsiveness of the system.

Moreover, conventional real-time transcription systems either do not maintain a fine-grained association between recognized character information, timestamps, and extracted words, or they maintain such associations in a manner that is not integrated with a generative AI workflow. Without an index that explicitly maps extracted words to their occurrences and temporal positions in the transcript, the system cannot efficiently locate and supply only the most relevant contextual segments to a generative AI model. The computer therefore spends more processing cycles on context preparation, and the overall latency from user input to AI-generated response increases.

Accordingly, there is a need for an improved computer-implemented system that integrates real-time audio acquisition, speech recognition, natural language processing, index generation, and generative AI prompt sentence construction in a coordinated pipeline. Such a system should enable a processor to (i) continuously associate character information with time information, (ii) automatically extract and index words, (iii) infer user intent and conversational context based on user interactions and the index, and (iv) generate structured prompt sentences that instruct a generative AI model to produce context-aware responses. By tightly coupling these components, the computing system can reduce processing overhead, minimize unnecessary data transmission, and provide more relevant, timely responses during live conversations, thereby improving the functioning of the computer itself as an information processing platform.

The specific processing by the specific processing unit 290 of the data processing device 12 in Application Example 2 is realized by the following means.

The present invention provides a server comprising a processor configured to acquire audio information from an acoustic input device and convert the audio information into a digital signal; input the digital signal to a speech recognition algorithm to convert the audio information into character information and store the character information in association with time information; apply a natural language processing algorithm to the character information to extract words and to generate index information indicating a correspondence between the words and the character information; analyze user intent and context of the character information based on search information acquired from a user input device or based on the index information; generate, based on a result of the analysis, a prompt sentence described in a natural language that specifies a type of information requested and a response style for a generative AI model; input the prompt sentence to the generative AI model and acquire response information from the generative AI model; and present the response information to the user input device in a dialog format and record the response information in association with the character information and the index information. This enables the computing system to dynamically construct optimized prompt sentences tied to real-time, time-aligned transcript and index data, thereby reducing processing latency and resource consumption while improving the contextual relevance and responsiveness of AI-generated answers during ongoing conversations.

The term “system” refers to an arrangement of one or more computing devices and peripheral devices that cooperate to perform audio acquisition, speech recognition, natural language processing, prompt generation, interaction with a generative AI model, and presentation of response information to a user.

The term “processor” refers to a hardware-based computation unit, such as a central processing unit or a processing core, configured to execute instructions stored in a memory to perform operations including signal processing, text processing, analysis, and control of data flows within the system.

The term “audio information” refers to information representing sound, including human speech, captured as an analog or digital signal suitable for processing by the processor.

The term “acoustic input device” refers to a hardware device, such as a microphone or an array of microphones, configured to receive sound waves from an environment and convert the sound waves into an electrical or digital representation of audio information.

The term “digital signal” refers to a representation of audio information in a discrete-time, discrete-amplitude form, suitable for processing by digital computing circuitry and algorithms.

The term “speech recognition algorithm” refers to a software-implemented procedure executed by the processor that analyzes a digital signal representing speech and outputs corresponding character information representing recognized linguistic content.

The term “character information” refers to data representing textual content derived from recognized speech, including symbols, characters, or strings that encode words, sentences, and other language units.

The term “time information” refers to data indicating temporal positions or time intervals associated with portions of the character information or audio information, such as timestamps, durations, or sequence indices.

The term “natural language processing algorithm” refers to a software-implemented procedure executed by the processor that analyzes character information to perform linguistic tasks, including tokenization, part-of-speech tagging, parsing, entity recognition, and word or phrase extraction.

The term “word” refers to a linguistic unit, such as a token or term, identified within character information and used as a basis for indexing, context analysis, or query formulation.

The term “index information” refers to structured data indicating associations between words and corresponding character information, including positions, segments, or occurrences of the words within a transcript or document.

The term “user intent” refers to an inferred purpose or objective of a user's input, such as a desire to obtain a definition, a procedure, background information, or other specific content, as determined by analysis of search information and context.

The term “context of the character information” refers to surrounding textual and structural information related to a portion of character information, including neighboring words, sentences, conversational history, and associated metadata used to interpret meaning.

The term “search information” refers to information received from a user input device that expresses a user's request, such as a query term, a selected word, a question, or other input indicating a desired type of information.

The term “user input device” refers to a hardware device, such as a keyboard, pointing device, touch panel, microphone, or display-equipped terminal, through which a user provides search information or selects words or options.

The term “prompt sentence” refers to a textual instruction described in a natural language and generated by the processor to specify, for a generative AI model, at least a type of information requested and a desired response style.

The term “generative AI model” refers to a machine learning model configured to generate natural-language output content in response to textual input, including a prompt sentence, based on parameters learned from training data.

The term “response information” refers to content generated by the generative AI model in response to a prompt sentence, including explanations, definitions, instructions, summaries, or other textual outputs.

The term “dialog format” refers to a presentation style in which response information is displayed or provided in association with corresponding user inputs or prompts, such that an interaction appears as a sequence of conversational exchanges.

The term “unknown word” refers to a word extracted from character information that is indicated by a user or by system logic as not being understood or as requiring additional explanation or clarification.

The term “context information” refers to character information and related data in a vicinity of an occurrence of a word, including preceding and following text segments, which is used to interpret or explain the word in its conversational setting.

The term “explanation request” refers to a type of prompt sentence that explicitly instructs a generative AI model to generate explanation information regarding a specified word or concept, optionally including associated context information.

The term “explanation information” refers to response information generated by a generative AI model that provides a description, definition, clarification, or detailed explanation of a specified word or concept.

The term “conversation” refers to a sequence of utterances or exchanges involving one or more users and the system, captured as audio information and represented as character information over time.

The term “real time” refers to processing and presentation of information by the system with latency sufficiently low that outputs, including response information, are provided substantially contemporaneously with ongoing conversation.

The term “progress of the conversation” refers to temporal advancement and evolving content of a conversation, including newly acquired audio information, newly generated character information, and updated context for user requests.

The term “response style” refers to characteristics of response information requested from a generative AI model, such as level of detail, tone, formality, structure, or target audience, as specified in a prompt sentence.

In one embodiment, a server, a terminal, and a user cooperate to implement the claimed system. The server includes at least one processor, a memory, a network interface, and a non-transitory storage device. The terminal includes an acoustic input device such as a microphone, a display, and an input interface such as a keyboard, a pointing device, or a touch panel. The user operates the terminal to participate in a conversation, to provide search information, and to consume response information presented in a dialog format.

The server executes software modules that implement audio acquisition, speech recognition, natural language processing, index generation, prompt sentence construction, interaction with a generative AI model, and response presentation. The server uses general-purpose hardware and standard software frameworks. For example, the server uses an audio interface compatible with an operating system, a speech recognition service such as a cloud-based speech-to-text application programming interface, a natural language processing framework such as a tokenization and tagging library, and a generative AI inference engine such as a transformer-based language model. The server may run on commodity server hardware or on a virtual machine in a cloud computing environment.

The terminal captures audio information from the user using the microphone. The terminal converts analog audio signals to digital signals using an audio codec and device driver. The terminal transmits the digital signals to the server via a network protocol such as a secure transport protocol. The terminal also accepts typed or clicked input from the user as search information or as word selections and sends such information to the server over the same network connection.

The server receives digital signals representing audio information and executes a speech recognition algorithm. In one embodiment, the server uses a recurrent-neural-network or transformer-based acoustic model combined with a language model to map sequences of acoustic feature vectors (such as log-mel spectrogram features) to sequences of characters or tokens. The server computes acoustic features from the digital signals by applying windowing, Fourier transforms, and filter-bank projections. The server then feeds these features into a trained neural network that outputs character probabilities at each time step. The server decodes the probabilities using beam search with a language model to obtain character information. The server associates each recognized token with time information, such as start and end timestamps, and stores the character information with the corresponding time information in a transcript data structure. The transcript data structure may be implemented as a sequence of records, each record including a token, a word boundary flag, and a timestamp field.

The server applies a natural language processing algorithm to the character information stored in the transcript. The server uses a tokenizer to segment the character information into words and sentences. The server applies part-of-speech tagging and named entity recognition to each word using a statistical or neural tagging model. For example, the server uses a pre-trained transformer encoder to compute contextual embeddings for each token and applies a classification head to assign part-of-speech tags and entity labels. The server identifies words that satisfy certain importance criteria, such as high term frequency-inverse document frequency scores, membership in domain-specific technical vocabularies, or high attention weights from the transformer encoder. The server extracts such words as indexable terms.

The server generates index information that records a correspondence between each extracted word and its occurrences in the transcript. The index information may be implemented as an inverted index. For each word, the server stores a list of postings, where each posting includes at least a transcript identifier, a position in the character information, and associated time information. In some embodiments, the server also stores local context snippets, such as the sentence in which the word appears and neighboring sentences. The server writes the index information to a storage structure optimized for retrieval, such as a key-value store or a search-engine index.

The terminal periodically or on demand retrieves processed character information and index information from the server. The terminal displays the transcript aligned with time and highlights words that appear in the index. The terminal may display an index panel listing indexable words that are currently relevant to the ongoing conversation. The user views the display and selects a word by clicking or tapping. The user may also type a natural-language question related to that word in a text input field. The terminal packages the selected word, its position, and any typed question as search information and sends it to the server.

The server analyzes the search information and the context of the character information. The server retrieves the relevant index entry for the selected word and obtains surrounding context snippets from the transcript. The server uses a natural language processing algorithm, such as a transformer-based encoder, to jointly encode the user's search information and the context snippets. The encoder produces vector representations for the query and context, which the server uses to classify the user's intent among a set of categories, for example, “definition,” “step-by-step procedure,” “background explanation,” “latest status,” or “comparison.” The server may use a multi-layer neural classifier that takes as input the concatenated embeddings of the query and context and outputs an intent label and a confidence score.

Based on the intent label and context, the server constructs a prompt sentence for a generative AI model. The generative AI model may be a large transformer-based language model trained on textual corpora using an auto-regressive objective. The server builds a prompt sentence that explicitly instructs the generative AI model what type of information to generate and what response style to adopt. The prompt sentence is composed of fixed template segments and variable segments derived from the user's selected word, the inferred intent, and the context snippets.

For example, when the user selects a term and needs a definition, the server generates a prompt sentence such as:
“Explain the meaning of the term ‘AI’ in the context of an internal project meeting about machine learning and automation. Provide a concise, non-technical definition suitable for non-experts.”

When the user asks for a procedure in an industrial environment, the server generates a prompt sentence such as:
“Generate clear and step-by-step installation instructions for ‘part A’ used in the current assembly process. Assume the worker is in a noisy factory environment and needs short, practical steps.”

When the user searches for recent items, the server generates a prompt sentence such as:
“The user searched for ‘latest movies’ during a discussion about entertainment trends. Propose relevant content including recent movie releases, short reviews, and brief descriptions of trailers and related news articles.”

When the user asks the system to explain a term in context, the server may generate a prompt sentence such as:
“Provide detailed information related to the term ‘X’ mentioned in the following meeting context: [context text].”

The server inputs the generated prompt sentence to the generative AI model. The server maintains a communication module that packages the prompt sentence into an application programming interface call. The generative AI model, implemented as a transformer network with multiple self-attention layers and feed-forward layers, receives the prompt sentence as a sequence of tokens and computes output token probabilities conditioned on the input tokens. The model uses learned parameters obtained from pre-training and fine-tuning. During inference, the server controls decoding parameters such as maximum output length, sampling strategy, and temperature. The server generates response information by iteratively selecting tokens according to the model's probability distribution until an end-of-sequence condition is met.

The server may apply post-processing to the response information. The server may remove irrelevant segments, adjust formatting into bullet points or numbered lists, and attach metadata such as references to transcript positions. The server then associates the response information with the original character information and index information, and stores the association in a response log. This response log provides a structured record linking user queries, context, prompt sentences, and generated responses.

The terminal receives the response information and displays it in a dialog format. The dialog format aligns each user input with the corresponding system output so that the user perceives a coherent conversational thread. In some embodiments, the terminal displays the response in a side panel next to the transcript. In other embodiments, the terminal uses text-to-speech functionality to convert the response information into audio and plays it through speakers or a headset.

The server may be configured to identify unknown words. The server can determine whether a word is unknown based on explicit user indication, such as the user selecting the word and requesting an explanation, or based on statistics, such as low frequency in a user-specific vocabulary. When the server identifies an unknown word, the server gathers context information that includes neighboring sentences, speaker identity, and related index entries. The server then generates an explanation request in the form of a prompt sentence that contains both the unknown word and the context information. For example, the server may construct:
“Explain the meaning of the term ‘X’ in detail for participants who are not familiar with it. Use the following meeting context as background: [context text].”

The server inputs this explanation request to the generative AI model and receives explanation information, which the terminal presents to the user. Because the prompt sentence includes structured context and intent, the generative AI model can focus on producing targeted explanation information rather than a generic definition. This yields improved precision and reduces the need for the user to refine queries.

The server may also be configured to operate in real time while a conversation is in progress. The server continuously receives digital signals from the terminal, executes speech recognition, updates the transcript and index information, and responds to search information or selections without requiring the conversation to pause. The server maintains data structures in memory that support incremental updates: the transcript data structure is append-only with time-ordered entries, and the index information is updated by inserting new postings for newly extracted words. The server uses buffered processing windows for speech recognition and natural language processing to maintain low latency.

By constraining the generative AI model's input to a compact prompt sentence that encapsulates the essential context and requested information type, the server reduces the volume of data that must be transmitted and processed. Instead of sending entire transcripts, the server sends only selected context snippets and intent-specifying language. This reduces network load and inference time at the generative AI model. The server also uses the index information to avoid scanning or re-encoding the entire transcript when constructing prompt sentences, which reduces processor load and memory accesses. As a result, the system achieves improved response latency and higher throughput under concurrent user sessions.

The server improves accuracy and robustness of context selection by using neural embeddings and index structures in combination. The natural language processing algorithm computes embeddings that capture semantic similarity, allowing the server to identify context segments that are semantically relevant even if the exact keywords differ. The index information provides fast symbolic lookup, enabling the server to quickly locate precise positions and timestamps. This hybrid approach to context retrieval improves the quality of the prompt sentence and consequently the quality of the generated response.

The generative AI model used by the server may be trained on general corpora and optionally fine-tuned with domain-specific transcripts. During training, the model parameters are updated by minimizing a loss function such as cross-entropy between predicted and ground-truth tokens. The model uses backpropagation and gradient-based optimization to update weights in attention layers and feed-forward layers. Data augmentation techniques, such as random masking or shuffling of sentences, may be used during fine-tuning to increase robustness. The server, however, does not perform training during inference; instead, the server uses the trained model to generate responses. The server may maintain multiple generative AI models with different sizes or specializations and select among them based on the type of request inferred from the search information.

The system as implemented by the server and the terminal provides technical improvements beyond mere automation of human tasks. The server's use of time-aligned transcripts, structured index information, and intent-aware prompt sentence construction reduces redundant processing and optimizes the interaction with a generative AI model. The server avoids recomputing global context for every query and instead reuses the index and transcript structures. This reduces processor cycles and cache misses, which leads to faster query handling. The precise mapping between words and time information also enables efficient partial retranscription and correction when speech recognition updates earlier segments, thereby improving data consistency.

The server improves data management by organizing conversation data into layered structures: raw audio, time-aligned character information, index information, query logs, prompt sentences, and generated responses. Each layer is explicitly linked to the others through identifiers and timestamps. This layered design allows the server to reuse intermediate results across user sessions, avoids duplication of large text blocks, and supports efficient archival and retrieval. The improved data organization contributes to enhanced scalability and reliability for long-running or multi-user environments.

In one variation, the terminal includes a head-mounted display and operates as a wearable device. The terminal streams audio to the server and renders response information directly in the user's field of view. In another variation, the server is integrated into an on-premises appliance that resides in a meeting room and communicates with local microphones and displays. In still another variation, the generative AI model is deployed on a separate inference accelerator device, such as a graphics processing unit or a tensor processing unit, and the server coordinates prompt sentence generation and model invocation over an internal high-speed interconnect.

The server may support additional configuration options. For example, the server may adjust the formality of the response style based on user preferences, which are encoded as parameters in the prompt sentence. The server may also limit the maximum token count for the generative AI model's response to reduce computation time. The system may employ caching of prompts and responses; if two queries generate equivalent prompt sentences, the server can serve a cached response, thereby reducing redundant computation.

The system's processing rules differ from conventional rule-based systems that simply map keywords to canned responses. The server applies a non-trivial sequence of neural and symbolic operations to represent and interpret context, to select relevant context segments, and to encode this information into prompt sentences. The rules for selecting segments are based on both statistical measures (such as importance scores derived from attention weights) and structural constraints (such as proximity in time to the user's latest query). This combination of criteria yields a context selection mechanism that is not a simple human-like reading and summarization process but a specialized computational procedure tailored to maximize the generative AI model's effectiveness while constraining computational cost.

By designing the system in this way, the server improves the functioning of the computer itself as an information retrieval and dialogue engine. The coordinated use of speech recognition, natural language processing, indexing, and structured prompt sentence construction provides faster and more accurate responses with lower resource usage than conventional architectures that treat these components as loosely connected modules. The improved design thereby satisfies technical requirements for practical deployment, including reduced latency, improved throughput, better error tolerance, and more efficient data management in real-world conversational environments.

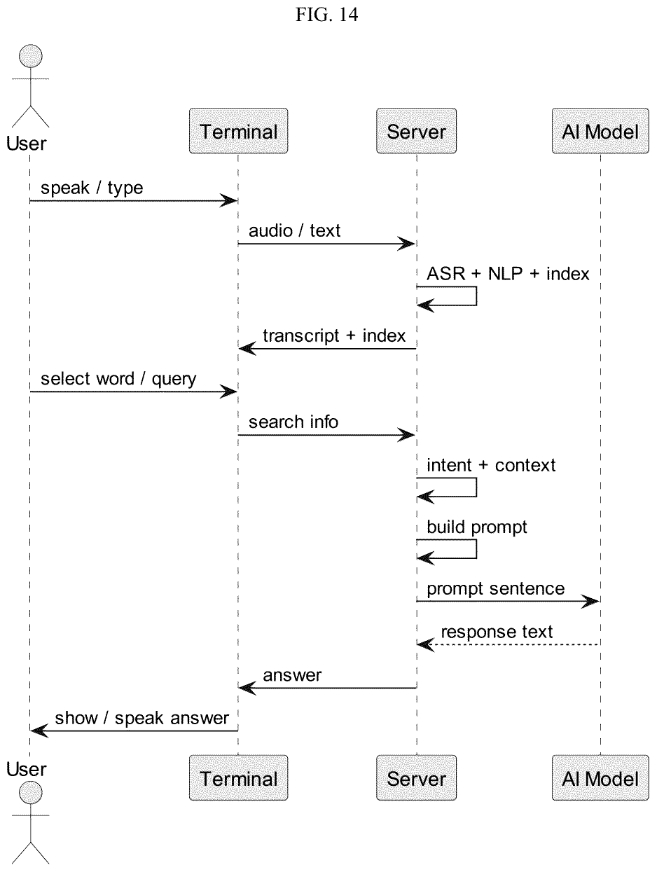

The following describes the processing flow using FIG. 14.

### Step 1

User speaks or types an input.

User provides audio input by speaking into a microphone of the terminal or provides text input by typing on a keyboard or touch panel of the terminal. The input is speech such as “What is the definition of AI?” or “Tell me the installation procedure for part A,” or a text query such as “latest movies.” The input of this step is raw human speech or textual characters, and the output is an audio signal at the terminal side or a text string ready to be sent to the server.

### Step 2

Terminal converts audio to a digital signal and sends data to the server.

Terminal receives the analog audio signal from the microphone, applies an analog-to-digital converter and audio driver to produce a digital signal (for example, a sequence of 16-bit samples at 16 kHz), and optionally buffers the samples into fixed-length frames. Terminal packages the digital signal or text string into a network message and transmits it to the server via a communication protocol. The input of this step is the analog audio waveform or typed characters, and the output is a digital audio stream or text payload sent over the network to the server.

### Step 3

Server performs speech recognition to generate time-aligned character information.

Server receives the digital audio stream and segments it into overlapping frames (for example, 25 ms windows with 10 ms stride). Server computes acoustic features such as log-mel filter bank energies from each frame. Server inputs the sequence of acoustic feature vectors into a trained speech recognition model, such as a neural network combining an acoustic model and a language model. Server performs decoding with beam search to select the most probable token sequence that represents the spoken utterance. Server assigns start and end timestamps to each token based on frame indices and stores the resulting character information (words and sentences) together with time information in a transcript data structure. The input of this step is the digital audio stream, and the output is time-aligned character information.

### Step 4

Server applies natural language processing to extract words and generate index information.

Server tokenizes the character information into words and sentences using a tokenizer. Server computes contextual embeddings for each token using a language representation model and applies part-of-speech tagging and named entity recognition to identify the grammatical roles and entities. Server calculates importance scores for tokens, for example using term frequency-inverse document frequency or attention weights from the embeddings, and selects tokens exceeding a threshold as index words. Server constructs index information in the form of an inverted index mapping each selected word to a list of positions, timestamps, and local context snippets in the transcript. The input of this step is the time-aligned character information, and the output is index information that links extracted words to their occurrences.

### Step 5

Terminal retrieves and displays transcript and index to the user.

Terminal periodically sends a request to the server for updated transcript segments and index information or receives push notifications from the server. Terminal renders the transcript in a scrolling view, placing each sentence according to its time information, and visually highlights words that appear in the index. Terminal may also show a side list of indexed words. The input of this step is the transcript data and index information from the server, and the output is a graphical display that the user can view and interact with.

### Step 6

User selects a word or submits search information.

User clicks or taps on a highlighted word in the transcript or index panel, or enters a search query into a text input field. User can type a question such as “What does this mean?” or “Explain this in more detail.” The input of this step is the displayed transcript and index on the terminal, and the output is user-generated search information specifying at least one selected word and optionally a free-form question.

### Step 7

Terminal sends search information and context request to the server.

Terminal detects the user's selection or typed query, retrieves the corresponding word, its position in the transcript, and any associated text query, and constructs a request message containing this search information. Terminal may also include a small window of surrounding transcript text as preliminary context. Terminal sends the request to the server via the network interface. The input of this step is the user's selection or query, and the output is a structured search request delivered to the server.

### Step 8

Server analyzes user intent and retrieves contextual transcript segments.

Server receives the search request and locates the corresponding index entry for the selected word in the index information. Server retrieves context information around the selected word, such as the containing sentence and neighboring sentences, using the positions and timestamps stored in the index. Server encodes the search information and context text using a natural language encoder to produce vector representations. Server feeds these vectors to an intent classification module that applies a neural classifier or other algorithm to categorize the request into types such as “definition,” “procedure,” or “background explanation.” The input of this step is the structured search request and index information, and the output is an intent label and a set of selected context segments.

### Step 9

Server constructs an intent-specific prompt sentence for the generative AI model.

Server selects a prompt template corresponding to the intent label and fills template variables with the selected word, context segments, and any user-entered question. For a definition intent, server may create a prompt sentence such as “Explain the meaning of the term ‘AI’ in the context of an internal project meeting about machine learning and automation. Provide a concise, non-technical definition suitable for non-experts.” For a procedural intent, server may generate a prompt sentence such as “Generate clear and step-by-step installation instructions for ‘part A’ used in the current assembly process. Assume the worker is in a noisy factory environment and needs short, practical steps.” Server may also concatenate context excerpts at the end of the prompt. The input of this step is the selected word, intent label, and context text, and the output is a prompt sentence tailored for the generative AI model.

### Step 10

Server submits the prompt sentence to the generative AI model and generates response information.

Server creates an API request containing the prompt sentence and parameters such as maximum output length and sampling strategy. Server sends this request to the generative AI model, which processes the tokenized prompt with a transformer-based architecture and returns a sequence of output tokens. Server converts the tokens to text and receives the generated content as response information. Server may remove extraneous phrases, format lists or steps, and attach metadata referencing the original transcript positions. The input of this step is the prompt sentence and model parameters, and the output is structured response information generated by the generative AI model.

### Step 11

Server associates response information with transcript and index and sends it to the terminal.

Server stores a record that links the user's search information, the prompt sentence, and the generated response information to the corresponding transcript and index entries using identifiers and timestamps. Server then creates a response message including the response text and any associated metadata and transmits this message to the terminal. The input of this step is the response information and existing transcript/index structures, and the output is a response payload ready for presentation at the terminal side.

### Step 12

Terminal presents the response information in dialog format and optionally as audio.

Terminal receives the response payload and inserts the response text into a dialog view, aligning the system's answer beneath the user's original query or selection so that a conversation thread is visible. Terminal may highlight related words in the transcript that are referenced by the answer. In environments requiring audio output, terminal invokes a text-to-speech engine to convert the response text into audio signals and plays them through speakers or a headset. The input of this step is the response payload from the server, and the output is a visual or audio presentation of the response information to the user.

### Step 13

User consumes the response and optionally issues follow-up requests.

User reads or listens to the response information, evaluates whether it answers the question, and may choose to click additional words, refine the query, or ask new questions. The input of this step is the displayed or played response information, and the output is any additional user interaction, which can trigger a new cycle starting from the selection or query steps.

### Step 14

Server maintains logs and updates data structures for future efficiency.

Server periodically or upon completion of an interaction writes detailed logs containing search information, prompt sentences, response information, and links to transcript and index entries into persistent storage. Server may use this data to optimize future processing, for example by caching prompt-response pairs or adjusting intent classification thresholds. The input of this step is the accumulated interaction data from previous steps, and the output is updated storage structures and configuration parameters that improve processing speed, accuracy, or resource utilization in subsequent interactions.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

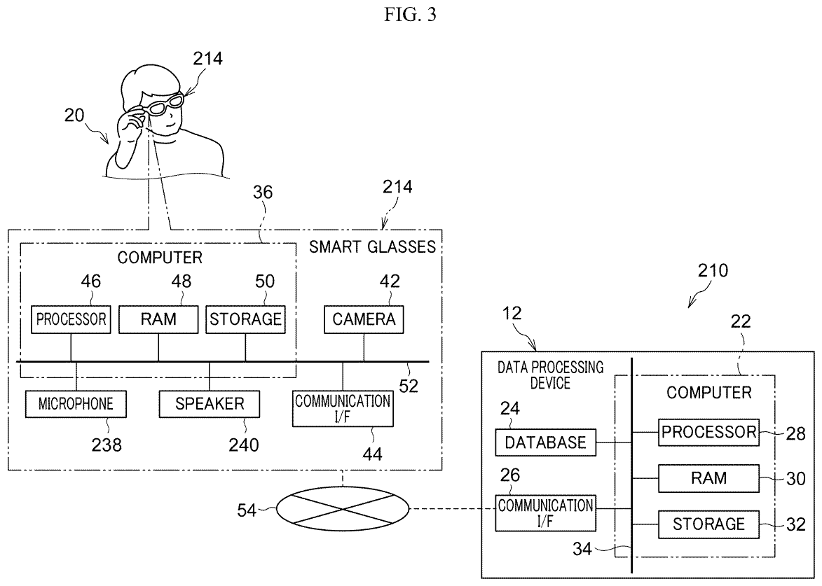

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

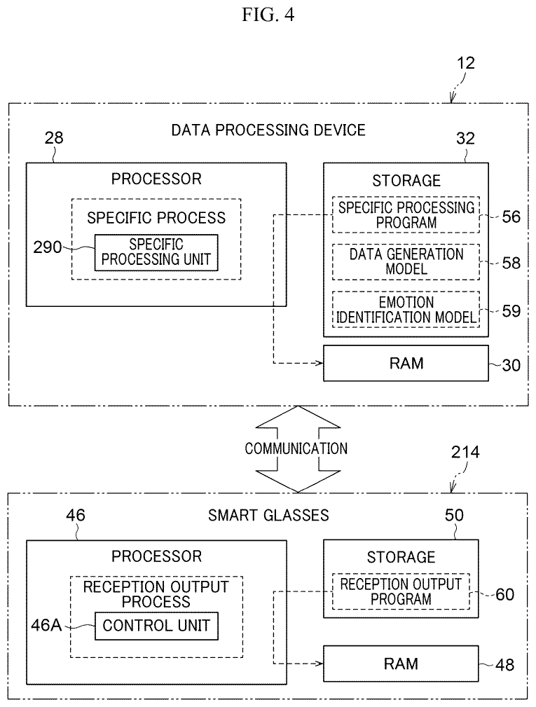

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

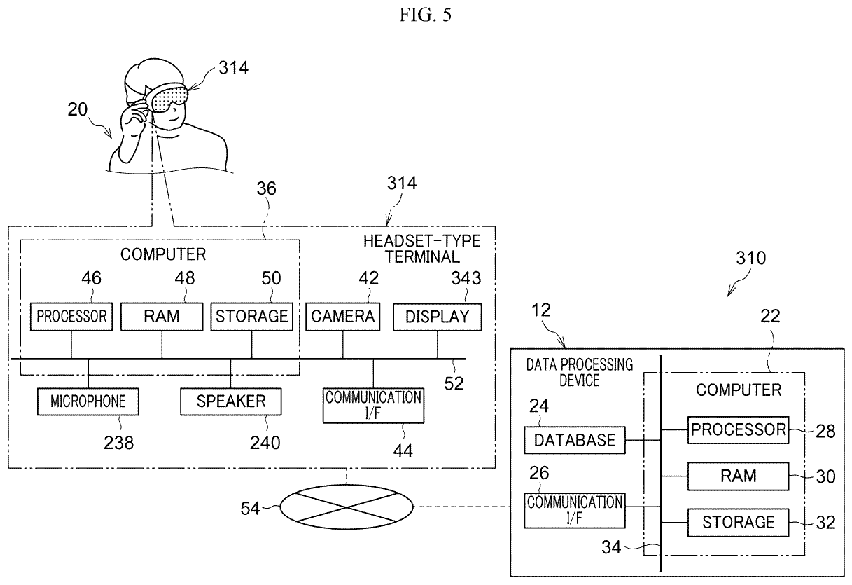

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

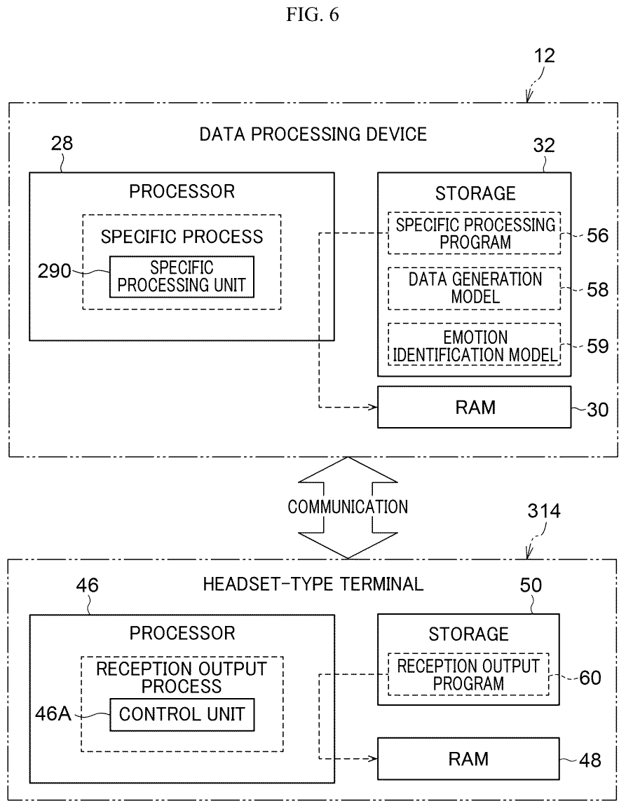

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https: //openai. com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

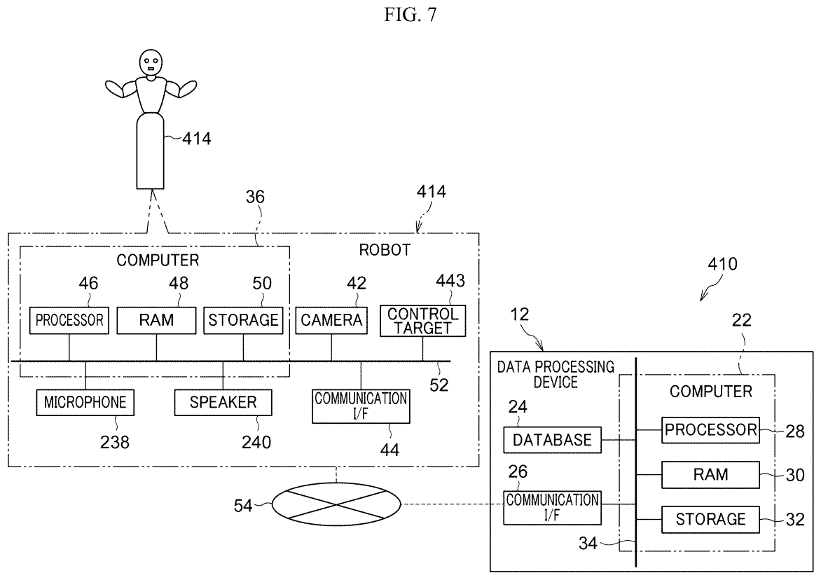

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

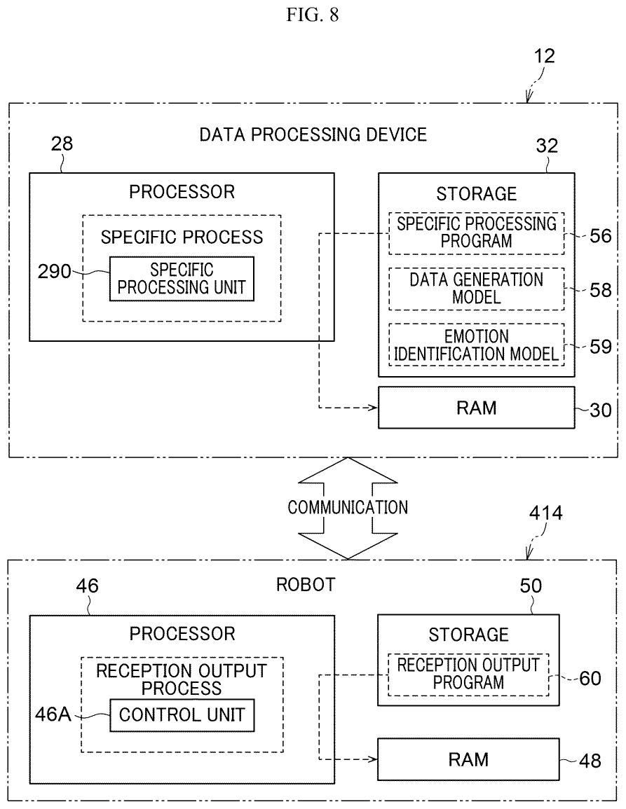

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

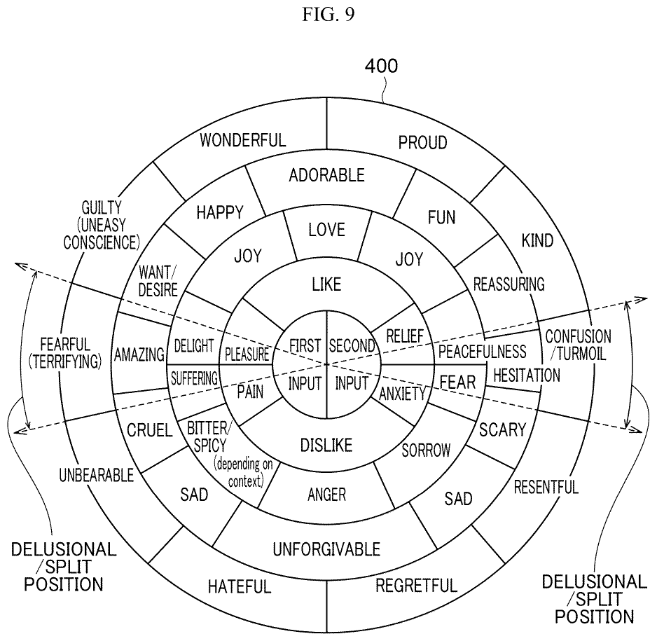

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

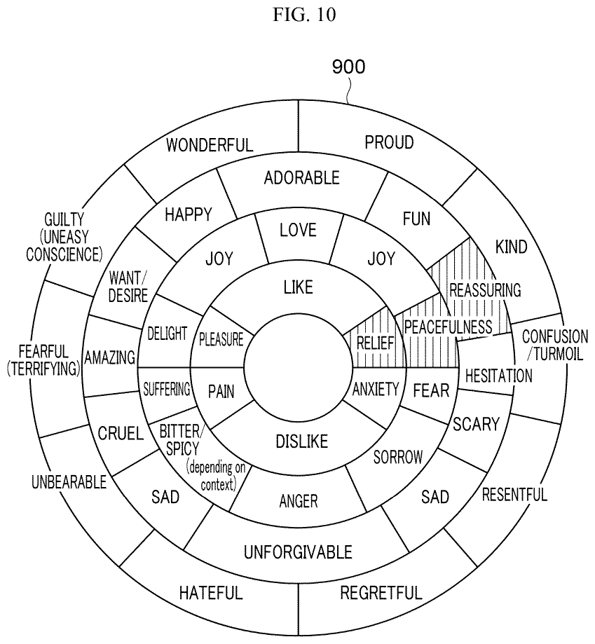

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire an acoustic signal by using an acoustic input device, and sample and quantize the acoustic signal to convert the acoustic signal into digital audio data, and
convert the digital audio data into character information by using an external speech recognition function, and generate a speech record including association information between the character information and the digital audio data, and
apply a natural language processing function to the character information to perform word segmentation, obtain part-of-speech information, syntactic information, and entity information, and extract important phrase candidates from the character information, and
calculate occurrence frequency information, importance indices, and mutual similarity for the important phrase candidates, and integrate the important phrase candidates into concept units to generate item index information as structured data, and
generate a prompt sentence that specifies processing contents for a generative information processing model based on the character information and the item index information, and input the prompt sentence and the character information into the generative information processing model to instruct correction of the item index information or generation of summary information, and
transmit the item index information and response information acquired from the generative information processing model to a user terminal device, and convert the item index information and the response information into a format visually presentable as a meeting record and an item index on the user terminal device.

### Supplementary 2

The system according to supplementary 1,
wherein the processor is configured to
dynamically generate the prompt sentence so as to instruct the generative information processing model to generate at least one of description information, background information, related information, and summary information regarding an unknown phrase or an important phrase selected according to a predetermined criterion in the character information, and store and present the description information and the like in association with the item index information.

### Supplementary 3

The system according to supplementary 1,
wherein the processor is configured to
generate the prompt sentence in real time each time the character information is sequentially added during progression of a meeting, sequentially update the item index information based on the response information from the generative information processing model, and incrementally transmit the updated item index information to the user terminal device so that detailed information requested during the meeting is immediately presentable.

### Application Example 1

### Supplementary 1

A system comprising a processor,
wherein the processor is configured to
acquire acoustic information via an electroacoustic transducer and convert the acoustic information into a digital signal,
execute speech recognition processing on the digital signal to convert the digital signal into character information,
execute natural language processing on the character information to perform morphological analysis and syntactic analysis and to extract expressions,
generate index information based on occurrence position information and occurrence frequency information of the extracted expressions, and store the index information in association with the character information in a storage device,
classify intent information indicating a user interest item and a movement destination based on the character information,
specify a target for assignment of location information based on the intent information and the index information, and search a storage device for location-related information corresponding to the target to acquire related information,
generate a prompt sentence, based on description request information including an expression selected by a user from among the character information and context information before and after the expression, the prompt sentence instructing a generative AI model to generate explanation information or recommendation information, and input the prompt sentence to the generative AI model, and
integrate the related information acquired by search and generated information acquired from the generative AI model, and control presentation of the integrated information in an interactive format to a user terminal.

### Supplementary 2

The system according to supplementary 1,
wherein the processor is configured to
generate, as the index information, meeting index information in real time based on the character information acquired during a meeting, the meeting index information associating agenda information, terminology information, and decision information with corresponding segments of the character information, and
generate, based on the meeting index information, a prompt sentence instructing the generative AI model to generate explanation information related to an unknown expression, and input the prompt sentence to the generative AI model.

### Supplementary 3

The system according to supplementary 1,
wherein the processor is configured to
classify, as the intent information, information indicating a demand for food, a demand for sightseeing, and a demand for lodging based on the character information acquired inside an autonomous mobile body,
acquire surrounding facility information based on current position information of the mobile body in accordance with the intent information,
generate a prompt sentence including the surrounding facility information and input the prompt sentence to the generative AI model, and
control real-time presentation of the surrounding facility information and recommendation information output from the generative AI model to a user.

### Example 2

### Supplementary 1

A system comprising a processor,
wherein the processor is configured to
use an acoustic input device to acquire audio information representing speech, and convert the acquired audio information into a time-series digital signal based on a predetermined sampling condition,
execute speech recognition processing using the digital signal as an input to sequentially generate character string data corresponding to the audio information, and store the character string data as text data in units of utterances or conversations,
apply a natural language processing algorithm to the text data to perform morphological analysis and part-of-speech analysis to extract words, generate index information indicating a correspondence between each word and the text data including the word, and store the index information in a search data structure,
control an information display device to display the words so that the words are selectable, receive a selection operation of a specific word from a user, and acquire the selected word and text data located around the selected word,
execute context analysis processing using the selected word and the surrounding text data as an input to generate context information indicating a semantic domain and a topic content in which the selected word is used,
generate a prompt sentence to be input to a generative processing algorithm by combining the context information and the selected word with template information, input the prompt sentence to a generative artificial intelligence model that executes the generative processing algorithm, and acquire answer text data generated by the generative artificial intelligence model, and
control the information display device to visually display the answer text data and to present, in real time during progress of the conversation, explanation information or detailed information related to the selected word.

### Supplementary 2

The system according to supplementary 1,
wherein the processor is configured to
determine, based on the context information, whether the selected word is an unknown word, and, when it is determined that the selected word is the unknown word, generate the prompt sentence that instructs generation of an explanation including definition information and usage-example information of the unknown word, and input the prompt sentence to the generative artificial intelligence model.

### Supplementary 3

The system according to supplementary 1,
wherein the processor is configured to
sequentially update the text data and the index information in association with a meeting session or a dialogue session, and, each time the selection operation of the word by the user occurs, generate, in real time, the prompt sentence using latest context information of the meeting session or the dialogue session, input the prompt sentence to the generative artificial intelligence model, and acquire the answer text data.

### Application Example 2

### Supplementary 1

A system comprising a processor,
wherein the processor is configured to
acquire audio information from an acoustic input device and convert the audio information into a digital signal,
input the digital signal to a speech recognition algorithm to convert the audio information into character information and store the character information in association with time information,
apply a natural language processing algorithm to the character information to extract words and generate index information indicating a correspondence between the words and the character information,
analyze user intent and context of the character information based on search information acquired from a user input device or based on the index information, generate a prompt sentence, described in a natural language, that specifies a type of information requested and a response style for a generative AI model, based on a result of the analysis,
input the prompt sentence to the generative AI model and acquire response information from the generative AI model, and
present the response information to the user input device in a dialog format and record the response information in association with the character information and the index information.

### Supplementary 2

The system according to supplementary 1,
wherein the processor is configured to
identify an unknown word from among the words extracted by the natural language processing algorithm based on a selection by a user, acquire context information including character information in a vicinity of an utterance in which the unknown word appears,
and generate, as the prompt sentence, an explanation request including the unknown word and the context information, input the explanation request to the generative AI model, and thereby acquire explanation information regarding the unknown word.

### Supplementary 3

The system according to supplementary 1,
wherein the processor is configured to
sequentially execute acquisition of the audio information, generation of the character information, extraction of the words, and generation of the index information while a conversation is in progress, sequentially generate the prompt sentence according to the search information acquired during the conversation or a word selected during the conversation, input the prompt sentence to the generative AI model, and present, in real time, response information following progress of the conversation to the user input device.

What is claimed is:

1. A system comprising:
circuitry configured to:
acquire acoustic signal data via an acoustic transducer and convert the acoustic signal data into a time-series digital signal based on a predetermined sampling condition;
execute a speech recognition algorithm on the time-series digital signal to sequentially generate character string data corresponding to the acoustic signal data;
apply a natural language processing algorithm to the character string data to perform morphological analysis and part-of-speech analysis to extract expression data from the character string data;
generate index information indicating a correspondence between each extracted expression and the character string data including the extracted expression, and store the index information in a search data structure; and
construct a parameterized instruction sequence based on at least the character string data and the index information, and provide the parameterized instruction sequence to a generative neural network model to cause the generative neural network model to generate structured output data.

2. The system according to claim 1, wherein the circuitry is further configured to:
calculate occurrence frequency information and importance index values for the extracted expression data, and compute mutual similarity values between pairs of extracted expressions using vector representations derived from a language embedding model.

3. The system according to claim 2, wherein the circuitry is further configured to:
integrate the extracted expressions into concept unit data by applying a clustering algorithm to group expressions having mutual similarity values exceeding a similarity threshold, and generate the index information as item index data comprising, for each concept unit, a canonical expression identifier, an aggregated importance index, and a list of occurrence position records.

4. The system according to claim 3, wherein each occurrence position record includes a segment identifier referencing a portion of the character string data, a token offset value, and a time stamp value derived from the time-series digital signal.

5. The system according to claim 4, wherein the circuitry is further configured to:
generate the parameterized instruction sequence to instruct the generative neural network model to produce at least one of corrected item index data and summary information data based on the character string data and the item index data, and receive response data from the generative neural network model comprising at least one of refined importance index values, updated category labels, and condensed summary text.

6. The system according to claim 5, wherein the circuitry is further configured to:
parse the response data to identify structured sections corresponding to expressions and category labels, merge the parsed response data with the item index data by updating importance index values and adding explanatory text fields to item index entries, and create new item index entries when the response data identifies expressions not previously present in the item index data.

7. The system according to claim 6, wherein the circuitry is further configured to:
detect an unresolved expression within the character string data by determining that the expression has an importance index value exceeding a first threshold and a familiarity score below a second threshold, and construct a targeted parameterized instruction sequence instructing the generative neural network model to generate explanatory text data for the unresolved expression.

8. The system according to claim 7, wherein the targeted parameterized instruction sequence includes the unresolved expression, context data comprising character string data from sentences surrounding the unresolved expression, and a constraint specifying a response format suitable for non-expert recipients.

9. The system according to claim 8, wherein the circuitry is further configured to:
store the explanatory text data in association with the corresponding item index entry, and transmit the item index data and the explanatory text data to a terminal apparatus via a packet-switched network in a format suitable for visual presentation as a structured record display and an item index display on the terminal apparatus.

10. The system according to claim 5, wherein the generative neural network model comprises a transformer-based architecture including a plurality of self-attention layers, feed-forward layers, and normalization layers, and wherein the circuitry provides the parameterized instruction sequence as a token sequence to the transformer-based architecture together with decoding control parameters including a maximum output token count and a sampling temperature value.

11. The system according to claim 10, wherein the circuitry is further configured to:
generate a speech record data structure that associates the character string data with corresponding portions of the time-series digital signal via association information including segment identifiers and time offset values, and store the speech record data structure in a storage medium.

12. The system according to claim 11, wherein the natural language processing algorithm further performs syntactic analysis to obtain dependency relation data and entity recognition to obtain entity label data for tokens within the character string data, and wherein the circuitry extracts the expression data by selecting token spans that match predetermined syntactic patterns including noun phrase patterns and verb-object patterns.

13. The system according to claim 10, wherein the circuitry is further configured to:
classify intent information indicating a subject of interest and a target category based on the character string data by applying an intent classification model having an embedding layer, one or more hidden layers, and an output layer that computes probability distributions over a set of intent labels.

14. The system according to claim 13, wherein the circuitry is further configured to:
specify a target for assignment of supplementary information based on the intent information and the index information, search a storage device for supplementary data records corresponding to the target, and integrate the supplementary data records with generated information from the generative neural network model for presentation to the terminal apparatus.

15. The system according to claim 14, wherein the circuitry is further configured to:
receive, from the terminal apparatus, a selection signal identifying a specific expression from among displayed expression data, acquire context data comprising character string data located before and after the selected expression, and construct description request information including the selected expression and the context data.

16. The system according to claim 15, wherein the circuitry is further configured to:
execute context analysis processing using the selected expression and the context data to generate context information indicating a semantic domain and a topic content in which the selected expression is used, and incorporate the context information into the parameterized instruction sequence to cause the generative neural network model to generate context-aware explanatory text data.

17. The system according to claim 16, wherein the circuitry is further configured to:
present the generated explanatory text data and the supplementary data records to the terminal apparatus in an interactive dialog format, maintain state information for multi-turn interactions, and generate follow-up parameterized instruction sequences that reference prior response data to preserve conversational context across successive interactions.

18. A system comprising:
circuitry configured to:
acquire, via an acoustic transducer coupled to a communication interface, acoustic signal data and convert the acoustic signal data into a time-series digital signal;
execute a speech recognition algorithm on the time-series digital signal to generate character string data, and store the character string data in association with time information in a transcript data structure;
apply a natural language processing algorithm to the character string data to perform morphological analysis, part-of-speech analysis, and entity recognition to extract expression data, and generate index information mapping each extracted expression to occurrence position records within the character string data;
calculate importance index values for the extracted expressions, compute mutual similarity values between expression pairs using vector representations, and integrate expressions into concept unit data by clustering expressions exceeding a similarity threshold;
construct a parameterized instruction sequence based on the character string data, the index information, and the concept unit data, and provide the parameterized instruction sequence to a generative neural network model having a transformer-based architecture including a plurality of self-attention layers to generate structured output data; and
transmit the index information and the structured output data to a terminal apparatus via a packet-switched network for visual presentation.

19. The system according to claim 18, wherein the circuitry is further configured to:
receive a selection signal from the terminal apparatus identifying a specific expression, retrieve context data from the transcript data structure comprising character string data surrounding the selected expression, execute context analysis processing to determine a semantic domain and topic content, and construct a context-aware parameterized instruction sequence to cause the generative neural network model to generate explanatory text data tailored to the semantic domain and topic content.

20. A method performed by circuitry, the method comprising:
acquiring acoustic signal data via an acoustic transducer and converting the acoustic signal data into a time-series digital signal based on a predetermined sampling condition;
executing a speech recognition algorithm on the time-series digital signal to sequentially generate character string data corresponding to the acoustic signal data;
applying a natural language processing algorithm to the character string data to perform morphological analysis and part-of-speech analysis to extract expression data from the character string data;
generating index information indicating a correspondence between each extracted expression and the character string data including the extracted expression, and storing the index information in a search data structure; and
constructing a parameterized instruction sequence based on at least the character string data and the index information, and providing the parameterized instruction sequence to a generative neural network model to cause the generative neural network model to generate structured output data.
